(19) United States
(12) Patent Application Publication
(10) Pub. No.: US 2026/0357763 A1
(43) Pub. Date: Nov. 12, 2026

(54) CONTROLLER FOR INTERNAL COMBUSTION ENGINE

(71) Applicant: Mitsubishi Electric Mobility Corporation, Tokyo (JP)

(72) Inventors: Tatsuhiko TAKAHASHI, Tokyo (JP); Takeshi KITAO, Tokyo (JP); Tomokazu MAKINO, Tokyo (JP); Mitsuo WAKAYAMA, Tokyo (JP)

(73) Assignee: Mitsubishi Electric Mobility Corporation, Tokyo (JP)

(21) Appl. No.: 19/122,802

(22) PCT Filed: Apr. 26, 2023
(86) PCT No.: PCT/JP2023/016400

§ 371 Date: Apr. 21, 2025

(51) Int. Cl. F02D 41/14; F02D 41/00; F02D 41/22

(52) U.S. Cl. CPC F02D 41/1497; F02D 41/009; F02D 41/22; F02D 2200/024

(57) ABSTRACT

To provide a controller for an internal combustion engine which can determine the occurrence of abnormal combustion using a parameter which has little angular dependence and strongly expresses influence of the occurrence of abnormal combustion. A controller for an internal combustion engine calculates an increment of gas pressure torque by burning, based on the crank angular acceleration, at each crank angle; calculates an increment of gas pressure by burning, based on the increment of gas pressure torque by burning, at each crank angle; and determines presence or absence of the occurrence of abnormal combustion of the internal combustion engine, based on the increment of gas pressure by burning of each crank angle in a determination angle section.

### TECHNICAL FIELD

The present disclosure relates to a controller for an internal combustion engine.

### BACKGROUND ART

The preignition known as the abnormal combustion is a phenomenon in which the ignition plug or the deposit remaining in the cylinder becomes high temperature, this becomes a heat source, and self-ignition occurs before ignition by the ignition plug. The technology of patent document 1 detects the preignition by the fluctuation range of the rotational speed of the internal combustion engine.

For example, when the ignition timing of the specific cylinder is retarded by a certain angle, the output of the internal combustion engine is reduced and the rotational speed of the internal combustion engine is varied. At this time, when the preignition occurs in the specific cylinder, a flame is generated in the combustion chamber earlier than the ignition timing, and the fluctuation range of the rotational speed of the internal combustion engine becomes small. Therefore, the occurrence detection of preignition is performed by determining whether or not this fluctuation range of the rotational speed is smaller than the predetermined range (fluctuation range for preignition detection).

### CITATION LIST

### Patent Literature

Patent document 1: JP 2-136566 A

### SUMMARY OF INVENTION

### Technical Problem

In the internal combustion engine with the turbocharger, since the preignition including LSPI (Low Speed Pre-Ignition) which occurs especially in low rotation high load is accompanied by a rapid combustion in addition to an earlier combustion start timing, an earlier increasing timing of the gas pressure in cylinder, and a rapid increase in the gas pressure in cylinder are observed. The conversion from the force acting on the piston by the gas pressure increase due to the occurrence of preignition to the crank angular acceleration has angular dependence, the conversion coefficient becomes close to 0 in the vicinity of the top dead center where preignition occurs, and the influence of the occurrence of preignition appears small in crank angular acceleration. Accordingly, it is difficult to obtain the detection accuracy of the occurrence of preignition by the detection method which monitors the rotation fluctuation. The method for directly detecting the gas pressure in cylinder by adding the cylinder internal pressure sensor increases the cost.

Then, the purpose of the present disclosure is to provide a controller for an internal combustion engine which can determine the occurrence of abnormal combustion using a parameter which has little angular dependence and strongly expresses influence of the occurrence of abnormal combustion.

### Solution to Problem

A controller for an internal combustion engine according to the present disclosure including:
an angle information detection unit that detects a crank angle and a crank angle acceleration, based on an output signal of a crank angle sensor;
a gas pressure calculation unit that calculates an increment of gas pressure torque by burning which is included in a gas pressure torque applied to a crankshaft by a gas pressure in cylinder, based on the crank angle and the crank angular acceleration, at each crank angle; and calculates an increment of gas pressure by burning, based on the increment of gas pressure torque by burning and the crank angle, at each crank angle; and
an abnormal combustion determination unit that determines presence or absence of an occurrence of abnormal combustion of the internal combustion engine, based on the increment of gas pressure by burning at each crank angle within a determination angle section which is set corresponding to a combustion period.

### Advantage of Invention

According to the controller for the internal combustion engine of the present disclosure, unlike the crank angular acceleration, the increment of gas pressure by burning has little angular dependence, and the influence of the occurrence of abnormal combustion appears well. Accordingly, based on the increment of gas pressure by burning, the presence or absence of the occurrence of abnormal combustion can be determined with good accuracy.

### BRIEF DESCRIPTION OF THE DRAWINGS

FIG. 1 is a schematic configuration diagram of the internal combustion engine and the controller for the internal combustion engine according to Embodiment 1;

FIG. 2 is a schematic configuration diagram of the internal combustion engine and the controller for the internal combustion engine according to Embodiment 1;

FIG. 3 is a block diagram of the controller for the internal combustion engine according to Embodiment 1;

FIG. 4 is a hardware configuration diagram of the controller for the internal combustion engine according to Embodiment 1;

FIG. 5 is a time chart for explaining the angle information detection processing according to Embodiment 1;

FIG. 6 is a figure for explaining the occurrence determination of preignition according to Embodiment 1;

FIG. 7 is a figure for explaining the occurrence determination of preignition according to Embodiment 1;

FIG. 8 is a figure for explaining the behavior of gas pressure in cylinder in normal burning state according to Embodiment 1;

FIG. 9 is a figure for explaining the behavior of the gas pressure in cylinder when the preignition occurs according to Embodiment 1;

FIG. 10 is a figure for explaining the occurrence determination of preignition according to Embodiment 1;

FIG. 11 is a figure for explaining the occurrence determination of preignition according to Embodiment 1;

FIG. 12 is a figure for explaining the occurrence determination of misfire according to Embodiment 1;

FIG. 13 is a figure for explaining the occurrence determination of misfire according to Embodiment 1;

FIG. 14 is a figure for explaining the behavior of gas pressure in cylinder when the misfire occurs according to Embodiment 1;

FIG. 15 is a figure for explaining the behavior of gas pressure in cylinder according to Embodiment 1;

FIG. 16 is a figure for explaining the occurrence determination of preignition according to Embodiment 2;

FIG. 17 is a figure for explaining the occurrence determination of misfire according to Embodiment 2;

FIG. 18 is a figure for explaining the occurrence determination of preignition according to Embodiment 2; and

FIG. 19 is a figure for explaining the occurrence determination of misfire according to Embodiment 2.

### DETAILED DESCRIPTION OF THE EMBODIMENTS

### 1. Embodiment 1

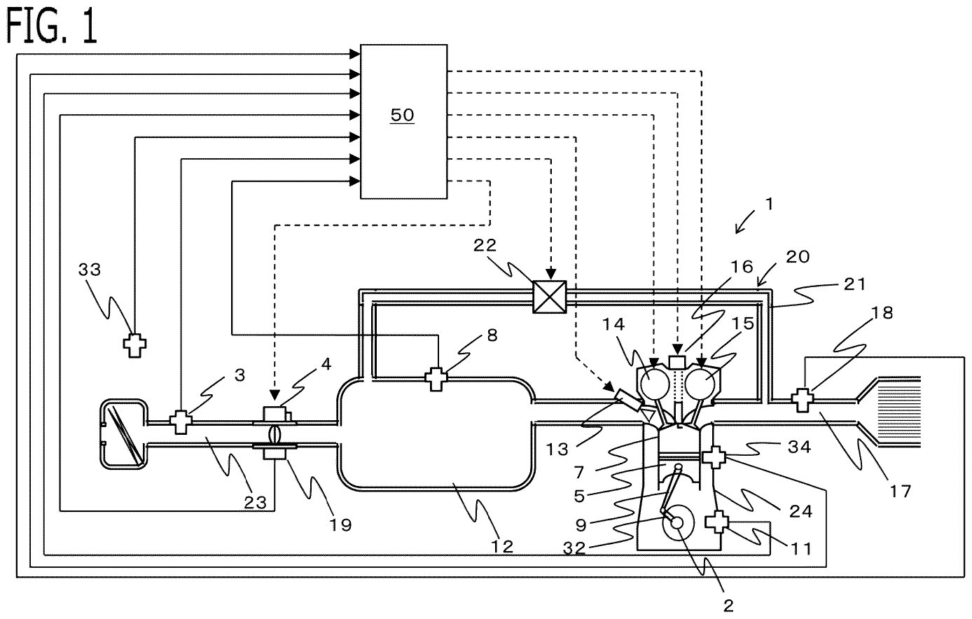

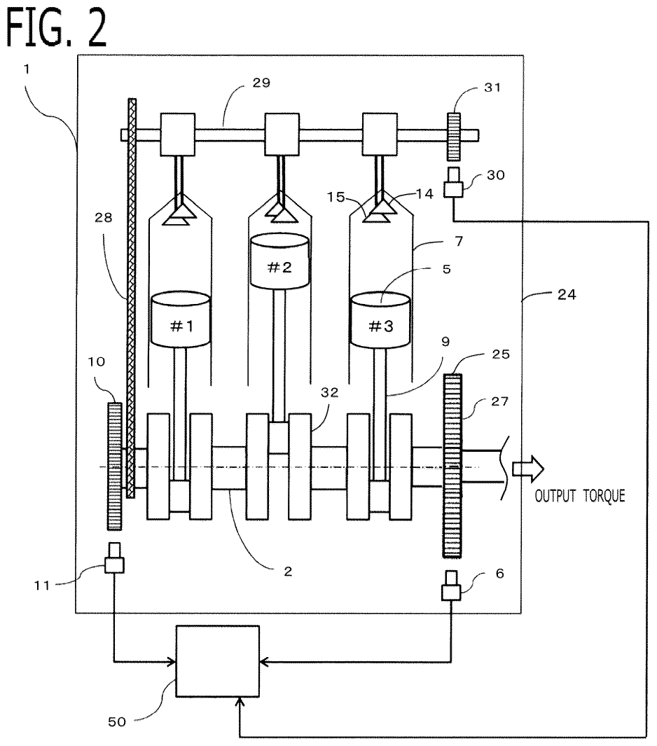

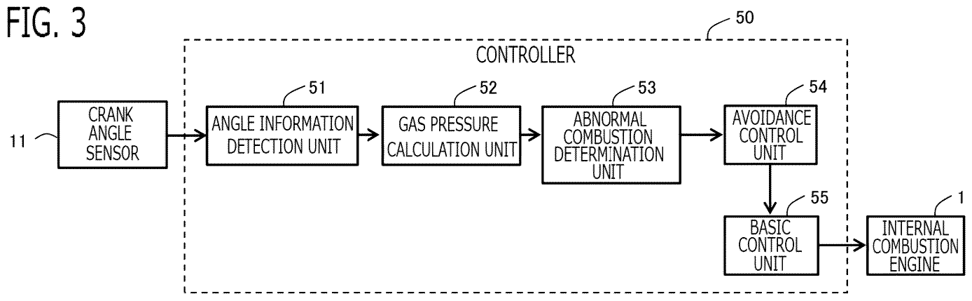

A controller 50 for an internal combustion engine 1 (hereinafter, referred to simply as the controller 50) according to Embodiment 1 will be explained with reference to the drawings. FIG. 1 and FIG. 2 are a schematic configuration diagram of the internal combustion engine 1 and the controller 50; FIG. 3 is a block diagram of the controller 50 according to Embodiment 1. The internal combustion engine 1 and the controller 50 are mounted in a vehicle; the internal combustion engine 1 functions as a driving-force source for the vehicle (wheels).

### 1-1. Configuration of Internal Combustion Engine 1

The configuration of the internal combustion engine 1 will be explained. As shown in FIG. 1, the internal combustion engine 1 is provided with cylinders 7 in which a fuel-air mixture is combusted. The internal combustion engine 1 is provided with an intake pipe 23 for supplying air to the cylinders 7 and an exhaust pipe 17 for discharging exhaust gas from the cylinders 7. The internal combustion engine 1 is a gasoline engine. The internal combustion engine 1 is provided with a throttle valve 4 which opens and closes intake pipe 23. The throttle valve 4 is an electronically controlled throttle valve which is opening/closing-driven by an electric motor controlled by controller 50. A throttle position sensor 19 which outputs an electric signal according to the opening degree of the throttle valve 4 is provided in the throttle valve 4.

An air flow sensor 3 which outputs an electric signal according to an intake air amount taken into the intake pipe 23 is provided in the intake pipe 23 on the upstream side of throttle valve 4. The internal combustion engine 1 is provided with an exhaust gas recirculation apparatus 20. The exhaust gas recirculation apparatus 20 is provided with an EGR passage 21 which recirculates the exhaust gas from the exhaust pipe 17 to the intake manifold 12, and an EGR valve 22 which opens and closes the EGR passage 21. The intake manifold 12 is a part of the intake pipe 23 on the downstream side of the throttle valve 4. The EGR valve 22 is an electronic controlled EGR valve which is opening/closing-driven by an electric motor controlled by controller 50. An air-fuel ratio sensor 18 which outputs an electric signal according to an air-fuel ratio of exhaust gas in the exhaust pipe 17 is provided in the exhaust pipe 17.

A gas pressure sensor 8 which outputs an electric signal according to a pressure in the intake manifold 12 is provided in the intake manifold 12. An injector 13 for injecting a fuel is provided on the downstream side part of the intake manifold 12. The injector 13 may be provided so as to inject a fuel directly into the cylinder 7. An atmospheric pressure sensor 33 which outputs an electric signal according to an atmospheric pressure Patm is provided in the internal combustion engine 1. A water temperature sensor 34 which detects a cooling water temperature is provided in the internal combustion engine 1.

An ignition plug for igniting a fuel-air mixture and an ignition coil 16 for supplying ignition energy to the ignition plug are provided on the top of the cylinder 7. An intake valve 14 for adjusting the amount of intake air to be taken from the intake pipe 23 into the cylinder 7 and an exhaust valve 15 for adjusting the amount of exhaust gas to be exhausted from the cylinder to the exhaust pipe 17 are provided on the top of the cylinder 7. The intake valve 14 is provided with an intake variable valve timing mechanism for varying the opening and closing timing thereof. The exhaust valve 15 is provided with an exhaust variable valve timing mechanism for varying the opening and closing timing thereof. Each of the variable valve timing mechanisms 14, 15 is provided with an electric actuator.

As shown in FIG. 2, the internal combustion engine 1 is provided with a plurality of cylinders 7 (in this example, three). A piston 5 is provided inside of each cylinder 7. The piston 5 of each cylinder 7 is connected to a crankshaft 2 via a connecting rod 9 and a crank 32. The crankshaft 2 is rotated by the reciprocating movement of the piston 5. A combustion gas pressure generated in each cylinder 7 presses the top face of the piston 5, and rotates the crankshaft 2 via the connecting rod 9 and the crank 32. The crankshaft 2 is connected with a power transfer mechanism which transmits driving force to the wheels. The power transfer mechanism is provided with a gearbox, a differential gear, and the like. The vehicle provided with the internal combustion engine 1 may be a hybrid vehicle provided with a motor generator in the power transfer mechanism.

The internal combustion engine 1 is provided with a signal plate 10 which rotates integrally with the crankshaft 2. A plurality of teeth are provided in the signal plate 10 at a plurality of preliminarily set crank angles. In the present embodiment, the teeth of the signal plate 10 are arranged at intervals of 10 degrees. The teeth of the signal plate 10 are provided with a chipped tooth part in which a part of teeth is chipped. The internal combustion engine 1 is provided with a crank angle sensor 11 which is fixed to an engine block 24 and detects the tooth of the signal plate 10.

The internal combustion engine 1 is provided with a cam shaft 29 connected with crankshaft 2 via a chain 28. The cam shaft 29 opens and closes the intake valve 14 and the exhaust valve 15. During the crankshaft 2 rotates twice, the cam shaft 29 rotates once. The internal combustion engine 1 is provided with a signal plate 31 for cam which rotates integrally with the cam shaft 29. A plurality of teeth are provided in the signal plate 31 for cam at a plurality of preliminarily set cam shaft angles. The internal combustion engine 1 is provided with a cam angle sensor 30 which is fixed to the engine block 24 and detects the tooth of signal plate 31 for cam.

Based on two kinds of output signals of the crank angle sensor 11 and the cam angle sensor 30, the controller 50 detects the crank angle on the basis of the top dead center of each piston 5 and determines the stroke of each cylinder 7. The internal combustion engine 1 is a 4-stroke engine which has an intake stroke, a compression stroke, a combustion stroke, and an exhaust stroke.

Each of the crank angle sensor 11 and the cam angle sensor 30 outputs an electric signal according to change of the distance between each sensor and tooth by rotation of the crankshaft 2. The output signal of each angle sensor 11, 30 becomes a rectangular wave that a signal turns on or off when the distance between sensor and tooth is near or when the distance is far. An electromagnetic pickup type sensor is used for each angle sensor 11, 30, for example.

### 1-2. Configuration of Controller 50

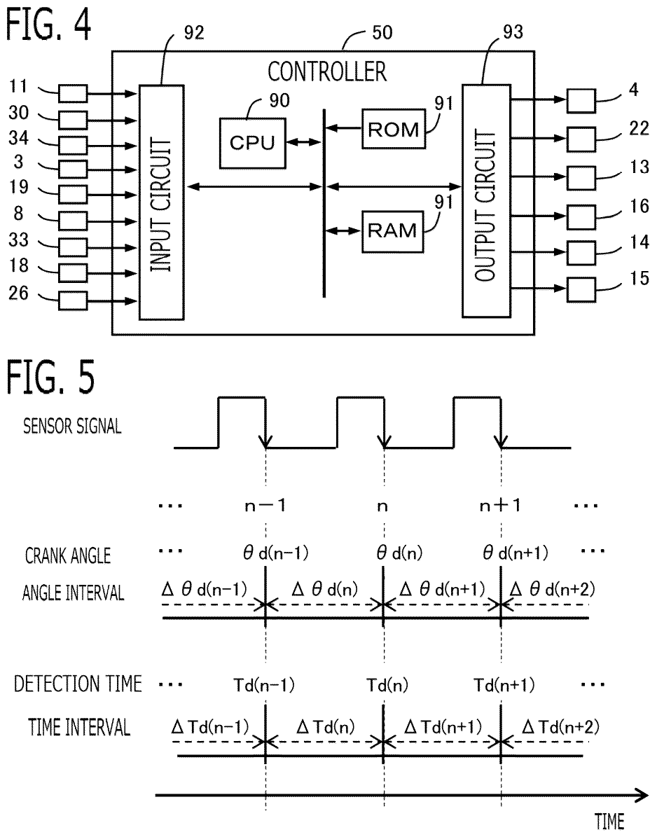

Next, the controller 50 will be explained. The controller 50 is a controller for controlling the internal combustion engine 1. As shown in FIG. 3, the controller 50 is provided with control units of an angle information detection unit 51, a gas pressure calculation unit 52, an abnormal combustion determination unit 53, an avoidance control unit 54, a basic control unit 55, and the like. The respective control units 51 to 55 of the controller 50 are realized by processing circuits provided in the controller 50. Specifically, as shown in FIG. 4, the controller 50 is provided with, as a processing circuit, an arithmetic processor (computer) 90 such as a CPU (Central Processing Unit), storage apparatuses 91 which exchange data with the arithmetic processor 90, an input circuit 92 which inputs external signals to the arithmetic processor 90, an output circuit 93 which outputs signals from the arithmetic processor 90 to the outside, and the like.

As the arithmetic processor 90, ASIC (Application Specific Integrated Circuit), IC (Integrated Circuit), DSP (Digital Signal Processor), FPGA (Field Programmable Gate Array), various kinds of logical circuits, various kinds of signal processing circuits, and the like may be provided. As the arithmetic processor 90, a plurality of the same type ones or the different type ones may be provided, and each processing may be shared and executed.

As the storage apparatus 91, volatile and nonvolatile storage apparatuses, such as RAM (Random Access Memory), ROM (Read Only Memory), and EEPROM (Electrically Erasable Programmable ROM), are provided. The input circuit 92 is connected with various kinds of sensors and switches and is provided with an A/D converter and the like for inputting output signals from the sensors and the switches to the arithmetic processor 90. The output circuit 93 is connected with electric loads and is provided with a driving circuit and the like for outputting a control signal from the arithmetic processor 90.

Then, the arithmetic processor 90 runs software items (programs) stored in the storage apparatus 91 such as a ROM and collaborates with other hardware devices in the controller 50, such as the storage apparatus 91, the input circuit 92, and the output circuit 93, so that the respective functions of the control units 51 to 55 provided in the controller 50 are realized. Various kinds of setting data such as each threshold value utilized in the control units 51 to 55 are stored in the storage apparatus 91, such as ROM, and EEPROM. Each calculation value and each detection value, such as the crank angle speed ωd, the crank angular acceleration αd, the gas pressure in cylinder Pcyl, the gas pressure in cylinder in unburning state Pcyl_unbrn, and the increment of gas pressure by burning ΔPcyl_brn, which are calculated by each control unit 51 to 55, are stored in the rewritable storage apparatus 91, such as RAM.

In the present embodiment, the input circuit 92 is connected with the first crank angle sensor 11, the cam angle sensor 30, the water temperature sensor 34, the air flow sensor 3, the throttle position sensor 19, the gas pressure sensor 8, the atmospheric pressure sensor 33, the air fuel ratio sensor 18, the accelerator position sensor 26, and the like. The output circuit 93 is connected with the throttle valve 4 (electric motor), the EGR valve 22 (electric motor), the injector 13, the ignition coil 16, the intake-air variable valve timing mechanism 14, the exhaust-gas variable valve timing mechanism 15, and the like. The controller 50 is connected with various kinds of unillustrated sensors, switches, actuators, and the like. The controller 50 detects operating conditions of the internal combustion engine 1, such as an intake air amount, a pressure in the intake manifold, an atmospheric pressure Patm, an air-fuel ratio, and an accelerator opening degree, based on the output signals of various sensors.

### 1-2-1. Basic Control Unit 55

As a basic control, the basic control unit 55 calculates a fuel injection amount, an ignition timing, and the like, based on the inputted output signals and the like from the various kinds of sensors, and then drives and controls the injector 13, the ignition coil 16, and the like. Based on the output signal of the accelerator position sensor 26 and the like, the basic control unit 55 calculates an output torque of the internal combustion engine 1 demanded by the driver, and then controls the throttle valve 4 and the like so that an intake air amount for realizing the demanded output torque is achieved. Specifically, the basic control unit 55 calculates a target throttle opening degree and then drives and controls the electric motor of the throttle valve 4 so that the throttle opening degree which is detected based on the output signal of the throttle position sensor 19 approaches the target throttle opening degree. And, the basic control unit 55 calculates a target opening degree of the EGR valve 22 based on the inputted output signals and the like from the various kinds of sensors and then drives and controls the electric motor of the EGR valve 22. The basic control unit 55 calculates a target opening and closing timing of the intake valve and a target opening and closing timing of the exhaust valve based on the output signals of the various sensors, and drives and controls the intake and the exhaust variable valve timing mechanisms 14, 15 based on each target opening and closing timing.

### 1-2-1. Angle Information Detection Unit 51

The angle information detection unit 51 detects a crank angle θd based on the output signal of the crank angle sensor 11, and calculates a crank angle speed ωd which is a time change rate of the detected crank angle θd, and a crank angular acceleration αd which is a time change rate of the crank angle speed ωd. The crank angle speed ωd corresponds to a rotational speed.

In the present embodiment, as shown in FIG. 5, the angle information detection unit 51 detects the crank angle θd based on the output signal of the crank angle sensor 11, and detects a detection time Td when the crank angle θd is detected. Then, the angle information detection unit 51 calculates an angle interval Δθd and a time interval ΔTd corresponding to the interval between the detected angles Gd, based on the detected angle θd which is the detected crank angle θd, and the detection time Td.

For example, the angle information detection unit 51 determines the crank angle θd when the falling edge (or rising edge) of the output signal (rectangular wave) of the crank angle sensor 11 is detected. The angle information detection unit 51 detects the crank angle θd on the basis of the top dead center TDC of the piston 5 of the first cylinder #1 and determines the stroke of each cylinder 7, based on two kinds of output signals of the crank angle sensor 11 and the cam angle sensor 30, using a well-known method.

<Calculation of Crank Angle Speed Od and Crank Angle Acceleration αd>

The angle information detection unit 51 calculates the crank angle speed ωd, based on each crank angle θd, and the detection time Td when each crank angle θd is detected. For example, as shown in the next equation, the angle information detection unit 51 calculates the crank angle speed ωd (n) at the present detected angle, based on the angle interval Δθd (n) between the crank angle θd (n) detected this time and the crank angle θd (n−1) detected the previous time, and the time interval ΔTd (n) between the present detection time Td (n) and the previous detection time Td (n−1). Various well-known methods other than this may be used for the of the wd.

$$\begin{matrix}[ Math . 1 ] & \\ Δ θ d ( n ) = θ d ( n ) - θ d ( n - 1 ) & ( 1 )\end{matrix}$$

$$Δ Td ( n ) = Td ( n ) - Td ( n - 1 )$$

$$ω d ( n ) = \frac{Δθ d ( n )}{Δ Td ( n )}$$

The angle information detection unit 51 calculates the crank angular acceleration αd based on the crank angle speed ωd. For example, as shown in the next equation, the angle information detection unit 51 calculates the crank angular acceleration αd (n) at the present detected angle, based on the crank angle speed ωd (n) calculated at the present detected angle, the crank angle speed ωd (n−1) calculated at the previous detected angle, and the time interval ΔTd (n) at the present detected angle. Various well-known methods other than this may be used for the of the ωd.

$$\begin{matrix}[ Math . 2 ] & \\ α d ( n ) = \frac{ω d ( n ) - ω d ( n - 1 )}{Δ Td ( n )} & ( 2 )\end{matrix}$$

The angle information detection unit 51 stores angle information, such as calculated the crank angle speed ωd and the crank angular acceleration αd, in the storage apparatus 91 such as RAM, for at least a period longer than the determination angle range described below, correlating with the corresponding crank angle θd.

### 1-2-3. Gas Pressure Calculation Unit 52

The gas pressure calculation unit 52 calculates an increment of gas pressure torque by burning ΔTgas_brn which is included in a gas pressure torque applied to the crankshaft by a gas pressure in cylinder, based on the crank angle θd and the crank angle acceleration αd, at each crank angle θd. The gas pressure calculation unit 52 calculates an increment of gas pressure by burning ΔPcyl_brn, based on the increment of gas pressure torque by burning ΔTgas_brn and the crank angle θd, at each crank angle θd. The details will be explained below.

### <Calculation of Shaft Torque in Unburning State Tcrk_Unbrn>

The gas pressure calculation unit 52 calculates a shaft torque in unburning state Tcrk_unbrn which is the shaft torque applied to the crankshaft by a gas pressure in cylinder in unburning state Pcyl_unbrn when assuming that the intake gas in cylinder is unburning and a reciprocating movement of piston, based on the crank angle θd, the crank angle speed ωd, and a condition of the intake gas amount in cylinder, at each crank angle θd.

In the present embodiment, the gas pressure calculation unit 52 calculates a gas pressure torque in unburning state Tgas_unbrn which is a shaft torque applied to the crankshaft by the gas pressure in cylinder in unburning state when assuming that the intake gas in cylinder is unburning, based on the crank angle θd and the condition of the intake gas amount in cylinder, at each crank angle θd. The gas pressure calculation unit 52 calculates a reciprocation inertia torque Tpstn which is a shaft torque applied to the crankshaft by the reciprocating movement of piston, based on the crank angle θd and crank angle speed ωd, at each crank angle θd. The gas pressure calculation unit 52 calculates the shaft torque in unburning state Tcrk_unbrn by adding the gas pressure torque in unburning state Tgas_unbrn and the reciprocation inertia torque Tpstn, at each crank angle θd. The details will be explained below.

The gas pressure calculation unit 52 calculates the gas pressure in cylinder in unburning state Pcyl_unbrn when assuming that the intake gas in cylinder is unburning, based on the present condition of the intake gas amount in cylinder (the present gas pressure in the intake pipe Pin, in this example), and the crank angle θd, at each crank angle θd.

In the present embodiment, the gas pressure calculation unit 52 calculates the gas pressure in cylinder in unburning state Pcyl_unbrn_i of each cylinder i using the next equation. For the cylinder i whose intake valve and exhaust valve are closed, by using the equation for calculating the gas pressure by the polytropic change, the gas pressure calculation unit 52 calculates the gas pressure in cylinder in unburning state Pcyl_unbrn_i of each cylinder i, based on the gas pressure in the intake pipe Pin and the crank angle θd. For the cylinder i whose intake valve is opened and whose exhaust valve is closed, the gas pressure calculation unit 52 calculates the gas pressure in cylinder in unburning state Pcyl_unbrn_i, based on the gas pressure in the intake pipe Pin. For the cylinder i whose exhaust valve is opened, the gas pressure calculation unit 52 calculates the gas pressure in cylinder in unburning state Pcyl_unbrn_i, based on the gas pressure in the exhaust pipe Pex.

$$[ Math . 3 ]$$

$$1 ) For cylinder whose intake valve and exhaust valve are closed ,$$

$$Pcyl\_unbrn \_i ( θd ) = {( \frac{Vcyl 0}{Vcyl\_θ \_i} )}^{Nply} \times Pin \qquad ( 3 )$$

$$Vcyl\_θ \_i = f ( θd\_i )$$

$$Vcyl\_θ \_i = Vcyltop + Sp \times \{ r + L - ( r \times cos ( θd\_i ) + L \times cos ( φ\_i ) ) \}$$

$$φ\_i = {sin}^{- 1} ( \frac{r \times sin ( θd\_i )}{L} )$$

$$2 ) For cylinder whose intake valve is opened and whose exhaust valve is closed , Pcyl\_unbrn \_i ( θ d ) = Pin$$

$$3 ) For cylinder whose exhaust valve is opened , Pcyl\_unbrn \_i ( θ d ) = Pex$$

Herein, Nply is a polytropic index, and a preliminarily set value is used. Vcyl0 is the cylinder volume of the combustion cylinder at valve closing of the intake valve. A preliminarily set value may be used for Vcyl0, or Vcyl0 may be changed according to the valve closing timing of the intake valve by the intake variable valve timing mechanism 14. Vcly_θ_i is the cylinder volume of each cylinder at the crank angle θd_i of each cylinder i, and becomes a function of the crank angle θd_i of each cylinder i. In the case of the offset crank, an offset may be considered in the calculation of the cylinder volume Vcly_θ. For example, the cylinder volume Vcly_θ_i of each cylinder i may be set based on the third equation and the fourth equation of the equation (3). Herein, Vcyltop is the cylinder volume when the piston is located at the top dead center. Sp is a projection area of the top face of the piston. r is a crank length. L is a connecting rod length, φ_i is an angle of the connecting rod of each cylinder i. For the crank angle θd_i of each cylinder i used for the calculation of the trigonometric function, a crank angle obtained by shifting the crank angle θd so that the top dead center of the compression stroke becomes 0 degree is used for each cylinder i.

The gas pressure calculation unit 52 calculates the gas pressure torque in unburning state Tgas_unbrn which is the shaft torque applied to the crankshaft by the gas pressure in cylinder in unburning state when assuming that the intake gas in cylinder is unburning, based on the gas pressure in cylinder in unburning state Pcyl_unbrn and the crank angle θd, at each crank angle θd.

In the present embodiment, using the next equation for converting the gas pressure into the torque, the gas pressure calculation unit 52 calculates the gas pressure torque in unburning state Tgas_unbrn, based on the gas pressure in cylinder in unburning state Pcyl_unbrn_i of each cylinder i, and the crank angle θd_i of each cylinder i.

$$\begin{matrix}[ Math . 4 ] & \\ Tgas\_unbrn = {\sum }_{i = 1}^{N} \{ ( Pcyl\_unbrn \_i - Patm ) \times Sp \times R\_i \} & ( 4 )\end{matrix}$$

$$R\_i = f ( θd\_i )$$

$$R\_i = r \times \{ sin ( θd\_i ) + tan ( φ\_i ) cos ( θd\_i ) \}$$

$$φ\_i = {sin}^{- 1} ( \frac{r \times sin ( θd\_i )}{L} )$$

Herein, R_i is a conversion coefficient for converting the force acting on the piston of each cylinder i into the torque, and is a function of the crank angle θd_i of each cylinder i. For example, the conversion coefficient R_i of each cylinder i may be set based on the third equation and the fourth equation of the equation (4). Alternatively, map data in which a relation between the crank angle θd and the conversion coefficient R is preliminarily set may be used. In the case of the offset crank, an offset may be considered in the calculation of the conversion coefficient R_i of each cylinder i. N is a cylinder number, and N is set to 3 in the present embodiment.

The gas pressure calculation unit 52 calculates a reciprocation inertia torque Tpstn which is the shaft torque applied to the crankshaft by the reciprocating movement of piston, based on the crank angle θd and crank angle speed ωd, at each crank angle θd.

In the present embodiment, using the next equation, the gas pressure calculation unit 52 calculates the reciprocation inertia torque Tpstn.

$$\begin{matrix}[ Math . 5 ] & \\ Tpstn = {\sum }_{i = 1}^{N} ( mp \times ω {d}^{2} \times Ka\_i \times R\_i ) & ( 5 )\end{matrix}$$

$$Ka\_i = f ( θ d\_i )$$

$$Ka\_i = r \times \{ cos ( θd\_i ) + \frac{r}{L} cos ( 2 \times θd\_i ) \}$$

Herein, mp is a mass of the piston. Ka_i is a coefficient for calculating an acceleration of the piston based on the crank angle speed ωd, and is a function of the crank angle θd_i of each cylinder i. For example, the acceleration calculation coefficient Ka_i of each cylinder i may be set based on the third equation of the equation (5). The third equation of the equation (5) is an approximate equation, but an exact value may be calculated. Alternatively, map data in which a relation between the crank angle θd and the acceleration arithmetic coefficient Ka is preliminarily set may be used. In the case of the offset crank, an offset may be considered in the calculation of the acceleration calculation coefficient Ka_i of each cylinder i. the conversion coefficient R_i of each cylinder i is similar to the equation (4). An inertia torque generated by the inertia of the connecting rod and the like may be added to the inertia torque Tin.

As shown in the next equation, the gas pressure calculation unit 52 calculates the shaft torque in unburning state Tcrk_unbrn by adding the gas pressure torque in unburning state Tgas_unbrn and the reciprocation inertia torque Tpstn, at each crank angle θd.

[Math. 6]

Tcrk_unbrn=Tgas_unbrn+Tpstn (6)

Alternatively, by referring to map data in unburning state in which a relation between the crank angle θd, the crank angle speed ωd, the condition of the intake gas amount in cylinder, and the shaft torque in unburning state Tcrk_unbrn is set, the gas pressure calculation unit 52 may calculate the shaft torque in unburning state Tcrk_unbrn corresponding to each crank angle θd, the crank angle speed ωd, and the condition of the intake gas amount in cylinder.

For example, the map data in unburning state is set for each operating state which affects the gas pressure torque in unburning state and the reciprocation inertia torque (in this example, the crank angle speed ωd and the condition of the intake gas amount in cylinder). The gas pressure calculation unit 52 calculates the shaft torque in unburning state Tcrk_unbrn corresponding to each crank angle θd by referring to the map data in unburning state corresponding to the present operating state. The map data in unburning state may be preliminarily set based on experimental data, and may be preliminarily set based on the theoretical equations of the equation (3) to the equation (6). The map data in unburning state may be updated based on the actual shaft torque Tcrkd actually calculated in the unburning state.

### <Calculation of Actual Shaft Torque Tcrkd>

The gas pressure calculation unit 52 calculates an actual shaft torque Tcrkd applied to the crankshaft, based on the crank angle acceleration αd, at each crank angle θd.

In the present embodiment, as shown in the next equation, the gas pressure calculation unit 52 calculates the actual shaft torque Tcrkd by multiplying the inertia moment Icrk of the crankshaft system to the crank angle acceleration αd, at each crank angle θd.

[Math. 7]

Tcrkd=αd=Icrk (7)

### <Calculation of External Load Torque Tload>

The gas pressure calculation unit 52 calculates an external load torque Tload which is a torque applied to the crankshaft from the outside of the internal combustion engine, based on the actual shaft torque Tcrkd_tdc and the shaft torque in unburning state Tcrk_unbrn_tdc which are calculated at the crank angle θd_tdc in the vicinity of the top dead center. Herein, the vicinity of the top dead center is within an angle interval from 10 degrees before the top dead center to 10 degrees after the top dead center, for example. For example, the crank angle θd_tdc in the vicinity of the top dead center is preliminarily set to the crank angle of the top dead center.

As shown in the next equation, the gas pressure calculation unit 52 calculates an external load torque in burning state Tload by subtracting the actual shaft torque Tcrkd_tdc in the vicinity of the top dead center from the shaft torque in unburning state Tcrk_unbrn_tdc in the vicinity of the top dead center.

[Math. 8]

Tload=Tcrk_unbrn_tdc−T_crkd_tdc (8)

Since the gas pressure torque of the combustion cylinder becomes about 0 in the vicinity of the top dead center of the combustion stroke, the external load torque Tload can be calculated with small arithmetic load, based on the shaft torque in unburning state Tcrk_unbrn_tdc in the vicinity of the top dead center, and the actual shaft torque in burning state Tcrkd_tdc in the vicinity of the top dead center.

### <Calculation of Increment of Gas Pressure Torque by Burning ΔTgas_Brn>

The gas pressure calculation unit 52 calculates the increment of gas pressure torque by burning ΔTgas_brn, based on the actual shaft torque Tcrkd, the shaft torque in unburning state Tcrk_unbrn, and the external load torque Tload, at each crank angle θd. In the present embodiment, as shown in the next equation, the gas pressure calculation unit 52 calculates the increment of gas pressure torque by burning ΔTgas_brn, by subtracting the shaft torque in unburning state Tcrk_unbrn from the actual shaft torque Tcrkd, and adding the external load torque Tload.

[Math. 9]

ΔTgas_brn=Tcrkd−Tcrk_unbrn+Tload (9)

### <Calculation of Increment of Gas Pressure by Burning ΔPcyl_Brn>

The gas pressure calculation unit 52 calculates an increment of gas pressure by burning ΔPcyl_brn, based on the increment of gas pressure torque by burning ΔTgas_brn and the crank angle θd, at each crank angle θd. In the present embodiment, the gas pressure calculation unit 52 calculates the increment of gas pressure in cylinder by burning ΔPcyl_brn using the next equation. The conversion coefficient R_brn is a conversion coefficient of the combustion cylinder among the conversion coefficient R_i of each cylinder i of the equation (4).

$$\begin{matrix}[ Math . 10 ] & \\ Δ Pcyl\_brn = \frac{Δ Tgas\_brn}{Sp \times R\_brn} & ( 10 )\end{matrix}$$

When the crank angle θd is 0 at the top dead center, the conversion coefficient R_brn of the combustion cylinder becomes zero, and divide by zero occurs. Accordingly, the gas pressure calculation unit 52 may calculate an average value of ΔPcyl_brn calculated at the crank angles before and after the top dead center, as ΔPcyl_brn at the top dead center.

### <Calculation of Gas Pressure in Cylinder Pcyl>

As shown in the next equation, at each crank angle θd, the gas pressure calculation unit 52 calculates the gas pressure in cylinder Pcyl by adding the gas pressure in cylinder in unburning state Pcyl_unbrn and the increment of gas pressure in cylinder by burning ΔPcyl_brn.

[Math. 11]

Pcyl=Pcyl_unbrn+ΔPcyl_brn (11)

The gas pressure calculation unit 52 stores the calculation values, such as the actual shaft torque Tcrkd, the shaft torque in unburning state Tcrk_unbrn, the increment of gas pressure torque by burning ΔTgas_brn, the increment of gas pressure in cylinder by burning ΔPcyl_brn, and the gas pressure in cylinder Pcyl, which are calculated at each crank angle θd, in the storage apparatus 91, such as RAM, together with angle information, such as the corresponding crank angle θd.

### 1-2-4. Abnormal Combustion Determination Unit 53

### <Determination Principle of Abnormal Combustion>

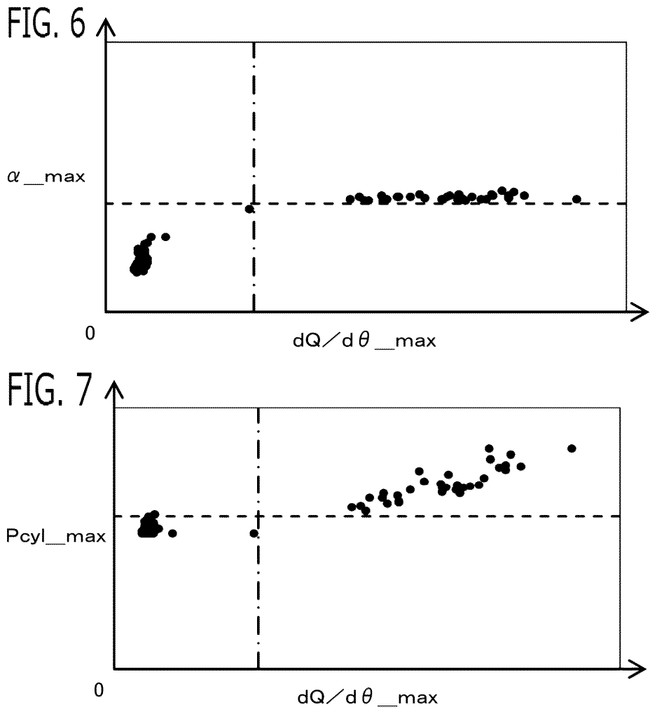

In the following, the determination principle of abnormal combustion will be explained. FIG. 6 plots a relation between a peak value of actual heat release rate dQ/dθ_max and a peak value of crank angular acceleration α_max at each combustion cycle, in the case where the combustion cycles in which preignition occurs, and the combustion cycles in which preignition does not occur are intermingled. Herein, the peak value of actual heat release rate dQ/dθ_max is a value calculated from the actual gas pressure in cylinder (for example, a value measured by the gas pressure sensor in cylinder). The peak value of crank angular acceleration α_max is a value calculated by the controller 50.

The increase in the peak value of crank angular acceleration α_max is not proportional to the increase in the peak value of actual heat release rate dQ/dθ_max. Accordingly, on the right side of the dashed line which is a region of the peak value of actual heat release rate dQ/dθ_max to be determined that preignition occurs, the peak value of crank angular acceleration α_max does not increase proportionally. Accordingly, it is difficult to set the determination threshold (broken line of FIG. 6) for determining the occurrence of preignition with good accuracy.

This is because the conversion from the force acting on the piston by the gas pressure increase caused by the occurrence of preignition to the crank angular acceleration α has an angular dependence, and the conversion coefficient R_brn of the combustion cylinder becomes close to zero in the vicinity of the top dead center where the preignition occurs, and the influence of the occurrence of preignition appears small in the crank angular acceleration α.

FIG. 7 plots a relation between a peak value of actual heat release rate dQ/dθ_max and a peak value of gas pressure in cylinder Pcyl_max calculated by the controller 50 at each combustion cycle, in the case where the combustion cycles in which preignition occurs, and the combustion cycles in which preignition does not occur are intermingled.

Since the peak value of gas pressure in cylinder Pcyl_max (above the broken line of FIG. 7) on the right side of the dashed line which is a region of the peak value of actual heat release rate dQ/dθ_max to be determined that preignition occurs, and the peak value of gas pressure in cylinder Pcyl_max (below the broken line of FIG. 7) on the left side of the dashed line which is a region of the peak value of actual heat release rate dQ/dθ_max to be determined that preignition does not occur cannot be clearly separated, it is difficult to set the determination threshold (broken line of FIG. 7) for determining the occurrence of preignition with good accuracy.

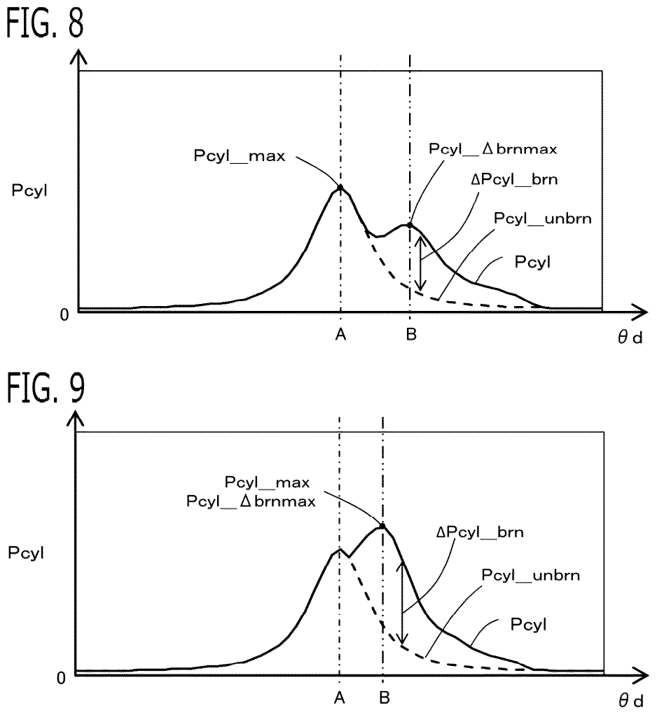

FIG. 8 shows an example of a change in the gas pressure in cylinder Pcyl and the like with respect to the crank angle θd in the combustion cycle (the compression stroke and the combustion stroke) where the preignition does not occur. The peak value of gas pressure in cylinder Pcyl_max becomes the gas pressure in cylinder Pcyl at the position of dashed line A. The gas pressure in cylinder Pcyl at the position of dashed line A is equal to the gas pressure in cylinder in unburning state Pcyl_unbrn (broken line) when assuming that the intake gas in cylinder is unburning.

FIG. 9 shows an example of a change in the gas pressure in cylinder Pcyl and the like with respect to the crank angle θd in the combustion cycle (the compression stroke and the combustion stroke) where the preignition occurs. The peak value of gas pressure in cylinder Pcyl_max is the gas pressure in cylinder Pcyl at the position of two-dot chain line B. Since a difference between the peak values of gas pressure in cylinder Pcyl_max of FIG. 9 and FIG. 8 is small, it is difficult to determine the preignition.

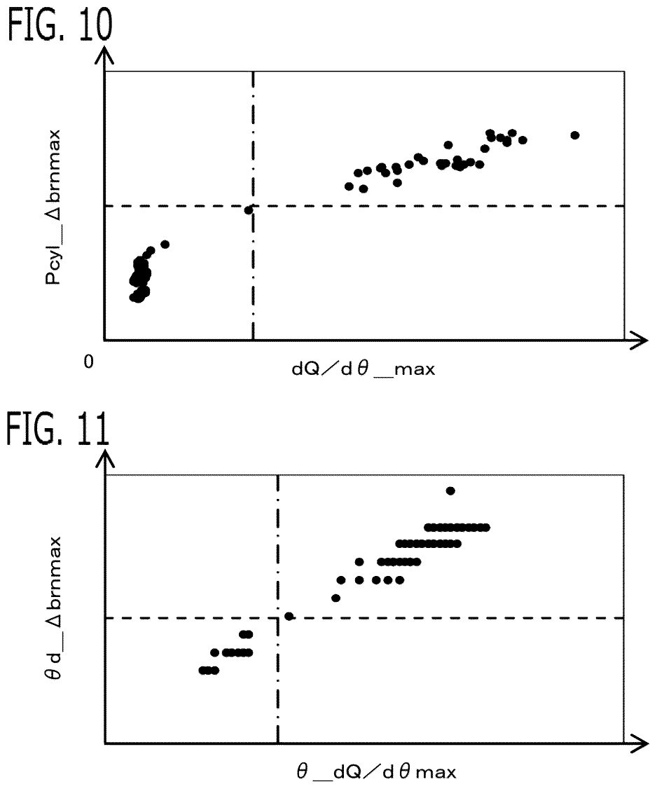

FIG. 10 plots a relation between the peak value of actual heat release rate dQ/dθ_max and the gas pressure in cylinder Pcyl_Δbrnmax at the crank angle corresponding to a peak value of the increment of gas pressure in cylinder by burning ΔPcyl_brn at each combustion cycle, in the case where the combustion cycles in which preignition occurs, and the combustion cycles in which preignition does not occur are intermingled. Herein, the peak value of actual heat release rate dQ/dθ_max is a value calculated from the actual gas pressure in cylinder (for example, a value measured by the gas pressure sensor in cylinder). ΔPcyl_brn and Pcyl_Δbrnmax are values calculated by the controller 50.

Since the gas pressure in cylinder Pcyl_Δbrnmax at the crank angle corresponding to the peak value of ΔPcyl_brn (above the broken line of FIG. 10) on the right side of the dashed line which is a region of the peak value of actual heat release rate dQ/dθ_max to be determined that preignition occurs, and the gas pressure in cylinder Pcyl_Δbrnmax at the crank angle corresponding to the peak value of ΔPcyl_brn (below the broken line of FIG. 10) on the left side of the dashed line which is a region of the peak value of actual heat release rate dQ/dθ_max to be determined that preignition does not occur can be clearly separated, it is possible to set the determination threshold (broken line of FIG. 10) for determining the occurrence of preignition with good accuracy. This is because, unlike the crank angular acceleration α, ΔPcyl_brn has little angular dependence, and the influence of the occurrence of preignition appears well.

As shown in FIG. 8 and FIG. 9, the gas pressure in cylinder Pcyl_Δbrnmax at the crank angle corresponding to the peak value of the increment of gas pressure in cylinder by burning ΔPcyl_brn is the gas pressure in cylinder Pcyl of the position of two-dot chain line B. A difference between the gas pressures in cylinder Pcyl_Δbrnmax corresponding to the peak values of ΔPcyl_brn of FIG. 8 and FIG. 9 is large. Accordingly, as shown in FIG. 10, it is possible to determine the preignition.

FIG. 11 plots a relation between the crank angle θ_dQ/dθmax corresponding to the peak value of actual heat release rate dQ/dθ_max and the crank angle θd_Δbrnmax corresponding to the peak value of increment of gas pressure in cylinder by burning ΔPcyl_brn at each combustion cycle, in the case where the combustion cycles in which preignition occurs, and the combustion cycles in which preignition does not occur are intermingled. Herein, the peak value of actual heat release rate dQ/dθ_max is a value calculated from the actual gas pressure in cylinder (for example, a value measured by the gas pressure sensor in cylinder). The crank angle θd_Δbrnmax corresponding to the peak value of increment of gas pressure in cylinder by burning ΔPcyl_brn is a value calculated by the controller 50.

Since the crank angle θd_Δbrnmax corresponding to the peak value of ΔPcyl_brn (above the broken line of FIG. 11) on the right side of the dashed line which is a region of the crank angle θ_dQ/dθmax corresponding to the peak value of actual heat release rate to be determined that preignition occurs, and the crank angle θd_Δbrnmax corresponding to the peak value of ΔPcyl_brn (below the broken line of FIG. 11) on the left side of the dashed line which is a region of the crank angle θ_dQ/dθmax corresponding to the peak value of actual heat release rate to be determined that preignition does not occur can be clearly separated, it is possible to set the determination threshold (broken line of FIG. 11) for determining the occurrence of preignition with good accuracy. This is because ΔPcyl_brn has little angular dependence, and the influence of the occurrence of preignition appears well.

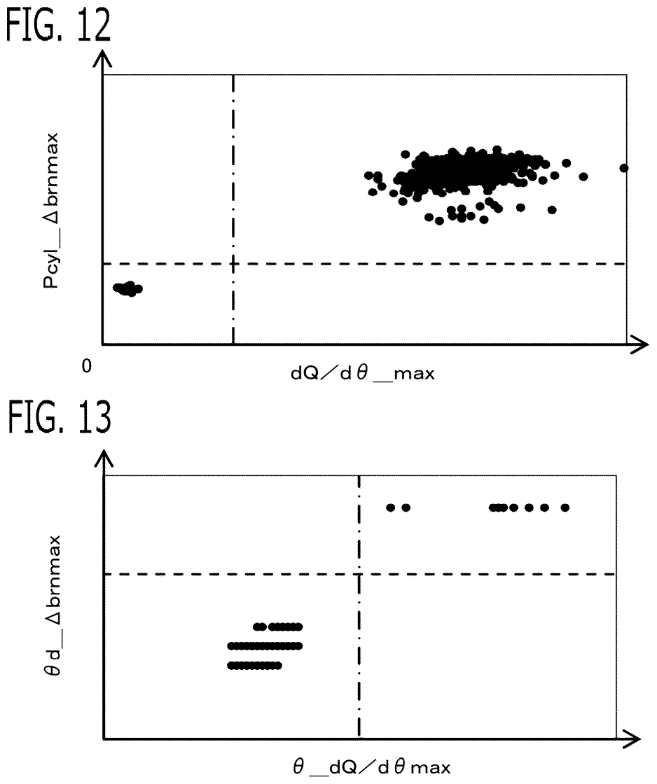

FIG. 12 plots a relation between a peak value of actual heat release rate dQ/dθ_max and the gas pressure in cylinder Pcyl_Δbrnmax at the crank angle corresponding to a peak value of the increment of gas pressure in cylinder by burning ΔPcyl_brn at each combustion cycle, in the case where the combustion cycles in which misfire occurs, and the combustion cycles in which misfire does not occur are intermingled. The scales of the horizontal axis and the vertical axis of FIG. 12 are expanded more than the scales of the horizontal axis and the vertical axis of FIG. 10. Herein, the peak value of actual heat release rate dQ/dθ_max is a value calculated from the actual gas pressure in cylinder (for example, a value measured by the gas pressure sensor in cylinder). ΔPcyl_brn and Pcyl_Δbrnmax are values calculated by the controller 50.

Since the gas pressure in cylinder Pcyl_Δbrnmax at the crank angle corresponding to the peak value of ΔPcyl_brn (below the broken line of FIG. 12) on the left side of the dashed line which is a region of the peak value of actual heat release rate dQ/dθ_max to be determined that misfire occurs, and the gas pressure in cylinder Pcyl_Δbrnmax at the crank angle corresponding to the peak value of ΔPcyl_brn (above the broken line of FIG. 12) on the right side of the dashed line which is a region of the peak value of actual heat release rate dQ/dθ_max to be determined that misfire does not occur can be clearly separated, it is possible to set the determination threshold (broken line of FIG. 12) for determining the occurrence of misfire with good accuracy. This is because, unlike the crank angular acceleration α, ΔPcyl_brn has little angular dependence, and the influence of the occurrence of misfire appears well.

FIG. 13 plots a relation between the crank angle θ_dQ/dθmax corresponding to the peak value of actual heat release rate dQ/dθ_max and the crank angle θd_Δbrnmax corresponding to the peak value of increment of gas pressure in cylinder by burning ΔPcyl_brn at each combustion cycle, in the case where the combustion cycles in which misfire occurs, and the combustion cycles in which misfire does not occur are intermingled. The scales of the horizontal axis and the vertical axis of FIG. 13 are expanded more than the scales of the horizontal axis and the vertical axis of FIG. 11. Herein, the peak value of actual heat release rate dQ/dθ_max is a value calculated from the actual gas pressure in cylinder (for example, a value measured by the gas pressure sensor in cylinder). The crank angle θd_Δbrnmax corresponding to the peak value of increment of gas pressure in cylinder by burning ΔPcyl_brn is a value calculated by the controller 50.

Since the crank angle θd_Δbrnmax corresponding to the peak value of ΔPcyl_brn (below the broken line of FIG. 13) on the left side of the dashed line which is a region of the crank angle θ_dQ/dθmax corresponding to the peak value of actual heat release rate to be determined that misfire occurs, and the crank angle θd_Δbrnmax corresponding to the peak value of ΔPcyl_brn (above the broken line of FIG. 13) on the right side of the dashed line which is a region of the crank angle θ_dQ/dθmax corresponding to the peak value of actual heat release rate to be determined that misfire does not occur can be clearly separated, it is possible to set the determination threshold (broken line of FIG. 13) for determining the occurrence of misfire with good accuracy. This is because, unlike the crank angular acceleration α, ΔPcyl_brn has little angular dependence, and the influence of the occurrence of misfire appears well.

As explained above, the presence or absence of the occurrence of abnormal combustion, such as preignition and misfire, can be determined by the increment of gas pressure in cylinder by burning ΔPcyl_brn with little angular dependence.

### <Determination of Abnormal Combustion>

Then, the abnormal combustion determination unit 53 determines presence or absence of an occurrence of abnormal combustion of the internal combustion engine, based on the increment of gas pressure by burning ΔPcyl_brn at each crank angle θd within a determination angle section Δθdet which is set corresponding to the combustion period.

As mentioned above, unlike the crank angular acceleration α, the increment of gas pressure by burning ΔPcyl_brn has little angular dependence, and the influence of occurrence of abnormal combustion appears well. Accordingly, based on the increment of gas pressure by burning ΔPcyl_brn, the presence or absence of the occurrence of abnormal combustion can be determined with good accuracy.

The determination angle section Δθdet is set to an angle section in the compression stroke and the combustion stroke so that the presence or absence of the occurrence of abnormal combustion can be determined. The compression stroke may not be included.

### <Determination of Preignition>

In the present embodiment, the abnormal combustion determination unit 53 determines a peak value of the increment of gas pressure by burning ΔPcyl_brn in the determination angle section Δθdet; and determines presence or absence of the occurrence of preignition by comparing the gas pressure in cylinder Pcyl_Δbrnmax at the crank angle θd corresponding to the peak value with a gas pressure threshold value for preignition ThP_pre.

As explained using FIG. 10, there is a trend difference in Pcyl_Δbrnmax between occurrence and non-occurrence of preignition. Accordingly, by setting the gas pressure threshold value for preignition ThP_pre between the Pcyl_Δbrnmax when preignition occurs, and Pcyl_Δbrnmax when preignition does not occur, the presence or absence of the occurrence of preignition can be determined with good accuracy.

The abnormal combustion determination unit 53 determines that preignition occurs, when the gas pressure in cylinder Pcyl_Δbrnmax corresponding to the peak value of ΔPcyl_brn exceeds the gas pressure threshold value for preignition ThP_pre; and determines that preignition does not occur, when the Pcyl_Δbrnmax is less than the gas pressure threshold value for preignition ThP_pre.

The abnormal combustion determination unit 53 sets the gas pressure threshold value for preignition ThP_pre, based on the operating state of the internal combustion engine. For example, by referring gas pressure threshold value data for preignition in which a relation between the operating state and the gas pressure threshold value ThP_pre is set, the abnormal combustion determination unit 53 sets the gas pressure threshold value for preignition ThP_pre corresponding to the present operating state. As the operating state of the internal combustion engine, the condition of the intake gas amount in cylinder (for example, the gas pressure in the intake pipe Pin, the intake air amount, or the like), the air-fuel ratio, the rotational speed (the rotational angle speed), and the like are used.

Alternatively, the abnormal combustion determination unit 53 may determine a peak value of the increment of gas pressure by burning ΔPcyl_brn in the determination angle section Δθdet; and may determine presence or absence of the occurrence of preignition by comparing the crank angle θd_Δbrnmax corresponding to the peak value with an angle threshold value for preignition Thθ_pre.

As explained using FIG. 11, there is a trend difference in θd_Δbrnmax between occurrence and non-occurrence of preignition. Accordingly, by setting the angle threshold value for preignition Thθ_pre between θd_Δbrnmax when preignition occurs, and θd_Δbrnmax when preignition does not occur, the presence or absence of the occurrence of preignition can be determined with good accuracy.

The abnormal combustion determination unit 53 determines that preignition occurs, when the crank angle θd_Δbrnmax corresponding to the peak value of ΔPcyl_brn exceeds the angle threshold value for preignition Thθ_pre; and determines that preignition does not occur, when θd_Δbrnmax is less than the angle threshold value for preignition Thθ_pre.

The abnormal combustion determination unit 53 sets the angle threshold value for preignition Thθ_pre, based on the operating state of the internal combustion engine. For example, by referring angle threshold value data for preignition in which a relation between the operating state and the angle threshold value Thθ_pre is set, the abnormal combustion determination unit 53 sets the angle threshold value for preignition Thθ_pre corresponding to the present operating state. As the operating state of the internal combustion engine, the condition of the intake gas amount in cylinder (for example, the gas pressure in the intake pipe Pin, the intake air amount, or the like), the air-fuel ratio, the rotational speed (the rotational angle speed), and the like are used.

### <Determination of Misfire>

The abnormal combustion determination unit 53 may determine a peak value of the increment of gas pressure by burning ΔPcyl_brn in the determination angle section Δθdet; and determines presence or absence of the occurrence of misfire by comparing the gas pressure in cylinder Pcyl_Δbrnmax at the crank angle θd corresponding to the peak value with a gas pressure threshold value for misfire ThP_mf.

As explained using FIG. 12, There is a trend difference in Pcyl_Δbrnmax between occurrence and non-occurrence of misfire. Accordingly, by setting the gas pressure threshold value for misfire ThP_mf between the Pcyl_Δbrnmax when misfire occurs, and Pcyl_Δbrnmax when misfire does not occur, the presence or absence of the occurrence of misfire can be determined with good accuracy.

The abnormal combustion determination unit 53 determines that misfire occurs, when the gas pressure in cylinder Pcyl_Δbrnmax corresponding to the peak value of ΔPcyl_brn is less than the gas pressure threshold value for misfire ThP_mf; and determines that misfire does not occur, when the Pcyl_Δbrnmax exceeds the gas pressure threshold value for misfire ThP_mf.

The abnormal combustion determination unit 53 sets the gas pressure threshold value for misfire ThP_mf, based on the operating state of the internal combustion engine. For example, by referring gas pressure threshold value data for misfire in which a relation between the operating state and the gas pressure threshold value ThP_mf is set, the abnormal combustion determination unit 53 sets the gas pressure threshold value for misfire ThP_mf corresponding to the present operating state. As the operating state of the internal combustion engine, the condition of the intake gas amount in cylinder (for example, the gas pressure in the intake pipe Pin, the intake air amount, or the like), the air-fuel ratio, the rotational speed (the rotational angle speed), and the like are used.

Alternatively, the abnormal combustion determination unit 53 may determine a peak value of the increment of gas pressure by burning ΔPcyl_brn in the determination angle section Δθdet; and may determine presence or absence of the occurrence of misfire by comparing the crank angle θd_Δbrnmax corresponding to the peak value with the angle threshold value for misfire Thθ_mf.

As explained using FIG. 13, there is a trend difference in θd_Δbrnmax between occurrence and non-occurrence of misfire. by setting the angle threshold value for misfire Thθ_mf between θd_Δbrnmax when misfire occurs, and θd_Δbrnmax when misfire does not occur, the presence or absence of the occurrence of misfire can be determined with good accuracy.

The abnormal combustion determination unit 53 determines that misfire occurs, when the crank angle θd_Δbrnmax corresponding to the peak value of ΔPcyl_brn is less than the angle threshold value for misfire Thθ_mf; and determines that misfire does not occur, when θd_Δbrnmax exceeds the angle threshold value for misfire Thθ_mf.

The abnormal combustion determination unit 53 sets the angle threshold value for misfire Thθ_mf, based on the operating state of the internal combustion engine. For example, by referring angle threshold value data for misfire in which a relation between the operating state and the angle threshold value Thθ_mf is set, the abnormal combustion determination unit 53 sets the angle threshold value for misfire Thθ_mf corresponding to the present operating state. As the operating state of the internal combustion engine, the condition of the intake gas amount in cylinder (for example, the gas pressure in the intake pipe Pin, the intake air amount, or the like), the air-fuel ratio, the rotational speed (the rotational angle speed), and the like are used.

### <Calculation of Peak Value of ΔPcyl_Brn Considering Misfire>

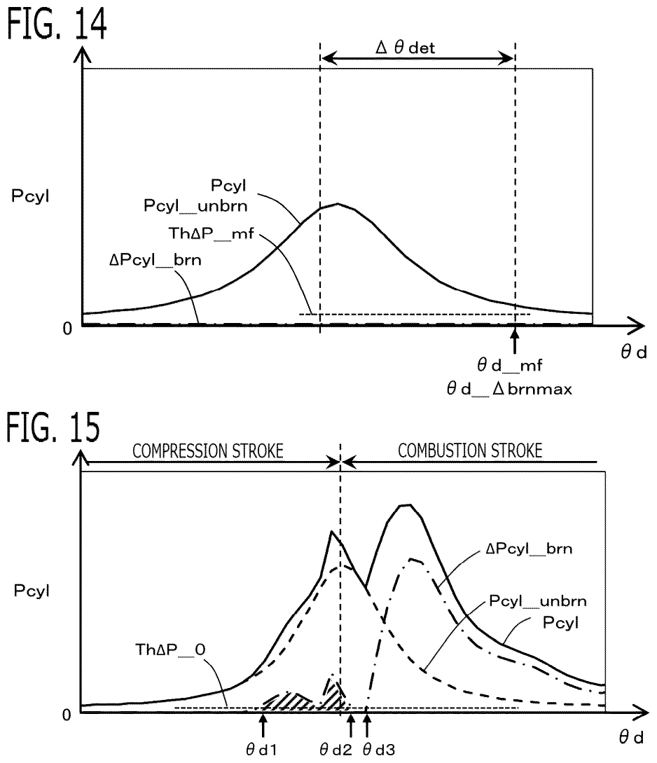

FIG. 14 shows an example of a change in the gas pressure in cylinder Pcyl and the like with respect to the crank angle θd in the combustion cycle (the compression stroke and the combustion stroke) where the misfire occurs. Since the increment of gas pressure in cylinder by burning ΔPcyl_brn becomes near zero when misfire occurs, it becomes difficult to determine the peak value, the crank angle θd_Δbrnmax corresponding to the peak value varies for every combustion cycle, and the determination error of misfire easily occurs.

Then, the abnormal combustion determination unit 53 may determine a peak value of the increment of gas pressure by burning ΔPcyl_brn in the determination angle section Δθdet; and sets a misfire state corresponding angle θd_mf preliminarily set in the determination angle section Δθdet, as the crank angle θd_Δbrnmax corresponding to the peak value, when the peak value is smaller than a misfire state corresponding threshold value ThΔP_mf.

According to this configuration, even when misfire occurred, the increment of gas pressure in cylinder by burning ΔPcyl_brn becomes near zero and it becomes difficult to determine the peak value, the misfire state corresponding angle θd_mf can be set as the crank angle θd_Δbrnmax corresponding to the peak value, θd_Δbrnmax can be prevented from varying for every combustion cycle, and the determination error of misfire can be suppressed.

The misfire state corresponding threshold value ThΔP_mf is set to a value larger than 0 considering a variation width of ΔPcyl_brn due to noise and variation factors, and the like when misfire occurs. For example, the misfire state corresponding angle θd_mf is set to the end angle of the determination angle section Δθdet, or is preliminarily set so as to correspond to the crank angle θd_Δbrnmax corresponding to the peak value when misfire does not occur.

### <Countermeasure Against Variation of ΔPcyl_brn>

FIG. 15 shows an example of a change in the gas pressure in cylinder Pcyl and the like with respect to the crank angle θd in the combustion cycle (the compression stroke and the combustion stroke) where the misfire does not occur. In this example, due to the influence of the angle variation of the teeth of the signal plate 10, before starting combustion, the increment of gas pressure in cylinder by burning ΔPcyl_brn becomes larger than zero (hatching part) Even in this case, since the peak value of ΔPcyl_brn after starting combustion becomes larger, the determination error of abnormal combustion does not occur. However, it is preferable that there is no increase in ΔPcyl_brn before starting combustion due to noise, variation factor, or the like. Further, since the calculation accuracy of the heat release rate dQ/de of Embodiment 2 and the mass combustion rate MFB of Embodiment 3 described below is deteriorated, it is preferable that there to be no increase in ΔPcyl_brn before starting combustion.

Then, when changing the crank angle θd to the retard angle side in the compression stroke and the combustion stroke (when changing the crank angle θd to the rotation direction), the gas pressure calculation unit 52 determines the crank angle θd where the increment of gas pressure by burning ΔPcyl_brn becomes larger than a zero excess determination threshold value ThΔP_0 for the first time in the compression stroke, as the first crank angle θd1; determines the crank angle θd where the increment of gas pressure by burning ΔPcyl_brn becomes less than or equal to the zero excess determination threshold value ThΔP_0 after the first crank angle θd1, as the second crank angle θd2; and determines the crank angle θd where the increment of gas pressure by burning ΔPcyl_brn becomes larger than the zero excess determination threshold value ThΔP_0 after the second crank angle θd2 in the combustion stroke after the compression stroke, as the third crank angle θd3. Then, when the first crank angle θd1 and the third crank angle θd3 exist, the gas pressure calculation unit 52 sets the increment of gas pressure by burning ΔPcyl_brn in an angle section corresponding to from the first crank angle θd1 to the second crank angle θd2 to zero.

According to this configuration, even when ΔPcyl_brn before starting combustion increases from zero due to noise, variation factor, or the like, ΔPcyl_brn before starting combustion can be corrected to zero. The zero excess determination threshold value ThΔP_0 is set to a value greater than or equal to zero.

### 1-2-4. Avoidance Control Unit 54

When it is determined that the abnormal combustion occurs by the Abnormal combustion determination unit 53, the avoidance control unit 54 controls the internal combustion engine by changing a control parameter of the internal combustion engine so as to suppress the occurrence of abnormal combustion. The control parameter to be changed includes one or more of the fuel injection amount, the intake gas amount in cylinder, the ignition timing, the EGR amount, and the control amount of the variable valve timing mechanism.

<when Preignition Occurs>

For example, if the fuel injection amount is included in the control parameter to be changed, the avoidance control unit 54 enriches (increases) the fuel injection amount more than a reference injection amount, and suppresses the occurrence of preignition by the fuel cooling, when it is determined that the preignition occurred. If the intake gas amount in cylinder is included in the control parameter to be changed, the avoidance control unit 54 decreases the intake gas amount in cylinder less than a reference intake gas amount, and suppresses the occurrence of preignition by the temperature decrease of compression gas in the vicinity of the top dead center, when it is determined that the preignition occurred. For example, the throttle valve 4 is controlled to the closing side. If the ignition timing is included in the control parameter to be changed, the avoidance control unit 54 changes the ignition timing to the retard angle side more than a reference ignition timing, and suppresses the occurrence of preignition by the decrease of combustion temperature, when it is determined that the preignition occurred.

If the EGR amount is included in the control parameter to be changed, the avoidance control unit 54 increases the EGR amount more than a reference EGR amount, and suppresses the occurrence of preignition by the decrease of fuel-air mixture ignitability and the decrease of combustion temperature, when it is determined that the preignition occurred. For example, the EGR valve 22 is controlled to the opening side. If the control amount of the variable valve timing mechanism is included in the control parameter to be changed, the avoidance control unit 54 changes the control amount of the variable valve timing mechanism to a side which suppresses the occurrence of preignition more than a reference control amount, and suppresses the occurrence of preignition, when it is determined that the preignition occurred. The control amount of the variable valve timing mechanism is the opening and closing timing of the exhaust valve, if the variable valve timing mechanism of the exhaust valve is controlled, and is the opening and closing timing of the intake valve, if the variable valve timing mechanism of the intake valve is controlled. For example, the control amount is changed so that an overlap period between the valve opening period of the exhaust valve and the valve opening period of the intake valve is increased, the internal EGR amount is increased, and the occurrence of preignition is suppressed by the decrease of fuel-air mixture ignitability and the decrease of combustion temperature.

When it is determined that the preignition occurred, the avoidance control unit 54 changes the reference control parameter calculated by the basic control unit 55 for the control parameter to be changed, and transmits the changed control parameter to the basic control unit 55, and reflects it on the control of the basic control unit 55. The avoidance control unit 54 gradually changes the control parameter to be changed to a side which suppresses the occurrence of preignition, when it is determined that the preignition occurred; and gradually returns the control parameter to be changed to the side opposite to the suppressing side, when it is determined that the preignition does not occur. The avoidance control unit 54 may increase the change amount of the control parameter to be changed to the side which suppresses the occurrence of preignition as the occurrence strength of preignition increases. If the control parameter to be changed can be changed for each cylinder, the control parameter to be changed of the cylinder where the preignition occurred may be changed.

### <When Misfire Occurs>

For example, if the fuel injection amount is included in the control parameter to be changed, the avoidance control unit 54 enriches (increases) the fuel injection amount more than a reference injection amount, and suppresses the occurrence of misfire, when it is determined that the misfire occurred. If the intake gas amount in cylinder is included in the control parameter to be changed, the avoidance control unit 54 increases the intake gas amount in cylinder more than the reference intake gas amount, and suppresses the occurrence of misfire, when it is determined that the misfire occurred. For example, the throttle valve 4 is controlled to the opening side. If the ignition timing is included in the control parameter to be changed, the avoidance control unit 54 changes the ignition timing to the advance angle side more than the reference ignition timing, and suppresses the occurrence of misfire, when it is determined that the misfire occurred.

If the EGR amount is included in the control parameter to be changed, the avoidance control unit 54 decreases the EGR amount less than the reference EGR amount, and suppresses the occurrence of misfire, when it is determined that the misfire occurred. For example, the EGR valve 22 is controlled to the closing side. If the control amount of the variable valve timing mechanism is included in the control parameter to be changed, the avoidance control unit 54 changes the control amount of the variable valve timing mechanism to a side which suppresses the occurrence of misfire more than a reference control amount, and suppresses the occurrence of misfire, when it is determined that the misfire occurred. The control amount of the variable valve timing mechanism is the opening and closing timing of the exhaust valve, if the variable valve timing mechanism of the exhaust valve is controlled, and is the opening and closing timing of the intake valve, if the variable valve timing mechanism of the intake valve is controlled. For example, the control amount is changed so that the overlap period between the valve opening period of the exhaust valve and the valve opening period of the intake valve is decreased, the internal EGR amount is decreased, and the occurrence of misfires is suppressed.

When it is determined that the misfire occurred, the avoidance control unit 54 changes the reference control parameter calculated by the basic control unit 55 for the control parameter to be changed, and transmits the changed control parameter to the basic control unit 55, and reflects it on the control of the basic control unit 55. The avoidance control unit 54 gradually changes the control parameter to be changed to a side which suppresses the occurrence of misfire, when it is determined that the misfire occurred; and gradually returns the control parameter to be changed to the side opposite to the suppressing side, when it is determined that the misfire does not occur. The avoidance control unit 54 may increase the change amount of the control parameter to be changed to the side which suppresses the occurrence of misfire as the occurrence frequency of misfire increases. If the control parameter to be changed can be changed for each cylinder, the control parameter to be changed of the cylinder where the misfire occurred may be changed.

### 2. Embodiment 2

The controller 50 according to Embodiment 2 will be explained with reference to drawings. The explanation for constituent parts the same as those in Embodiment 1 will be omitted. The basic configuration of the controller 50 according to the present embodiment is the same as that of Embodiment 1. Embodiment 2 is different from Embodiment 1 in that the gas pressure calculation unit 52 calculates a heat release rate dQ/dθd, and the abnormal combustion determination unit 53 determines presence or absence of the occurrence of abnormal combustion using the heat release rate dQ/dθd.

<Calculation of Heat Release Rate dQ/dθd>

The gas pressure calculation unit 52 calculates a heat release rate dQ/dθd per unit crank angle, based on the gas pressure in cylinder Pcyl and the crank angle θd, at each crank angle θd.

In the present embodiment, the gas pressure calculation unit 52 calculates the heat release rate dQ/dθd per unit crank angle using the next equation, at each crank angle θd.

$$\begin{matrix}[ Math . 12 ] & \\ \frac{d ( Q )}{d ( θ d )} = \frac{κ}{κ - 1} Pcyl \frac{d ( Vcyl\_θ )}{d ( θ d )} + \frac{1}{κ - 1} Vcyl\_θ \frac{d ( Pcyl )}{d ( θ d )} & ( 12 )\end{matrix}$$

Herein, K is a ratio of specific heat. Vcly_θ is a cylinder volume of the combustion cylinder at each crank angle θd, and is calculated as explained using the equation (3). The calculated heat release rate dQ/dθd of each crank angle θd is stored to the storage apparatus 91, such as RAM, similar to other calculation values.

### <Determination Principle of Abnormal Combustion>

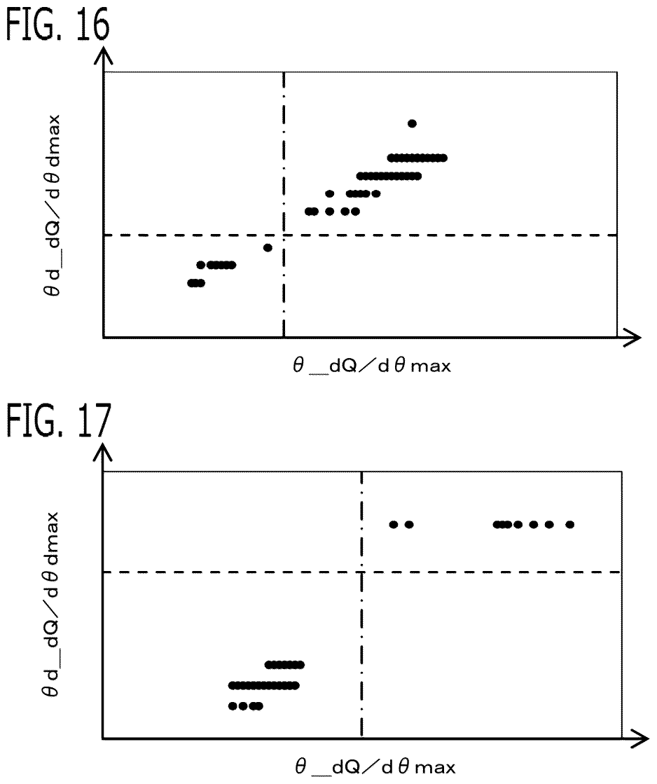

In the following, the determination principle of the abnormal combustion by the heat release rate dQ/dθd will be explained. FIG. 16 plots a relation between the crank angle θ_dQ/dθmax corresponding to the peak value of actual heat release rate dQ/dθ_max and the crank angle θd_dQ/dθdmax corresponding to the peak value of the heat release rate dQ/dθd_max calculated by the controller 50 at each combustion cycle, in the case where the combustion cycles in which preignition occurs, and the combustion cycles in which preignition does not occur are intermingled. Herein, the peak value of actual heat release rate dQ/dθ_max is a value calculated from the actual gas pressure in cylinder (for example, a value measured by the gas pressure sensor in cylinder).

Since the crank angle θd_dQ/dθdmax corresponding to the peak value of the heat release rate (above the broken line of FIG. 16) on the right side of the dashed line which is a region of the crank angle θ_dQ/dθmax corresponding to the peak value of actual heat release rate to be determined that preignition occurs, and the crank angle θd_dQ/dθdmax corresponding to the peak value of the heat release rate (below the broken line of FIG. 16) on the left side of the dashed line which is a region of the crank angle θ_dQ/dθmax corresponding to the peak value of actual heat release rate to be determined that preignition does not occur can be clearly separated, it is possible to set the determination threshold (broken line of FIG. 16) for determining the occurrence of preignition with good accuracy. This is because, unlike the crank angular acceleration α, the heat release rate dQ/dθd has little angular dependence, and the influence of the occurrence of preignition appears well.

FIG. 17 plots a relation between the crank angle θ_dQ/dθmax corresponding to the peak value of actual heat release rate dQ/dθ_max and the crank angle θd_dQ/dθdmax corresponding to the peak value of the heat release rate dQ/dθd_max calculated by the controller 50 at each combustion cycle, in the case where the combustion cycles in which misfire occurs, and the combustion cycles in which misfire does not occur are intermingled. The scales of the horizontal axis and the vertical axis of FIG. 17 are expanded more than the scales of the horizontal axis and the vertical axis of FIG. 16. Herein, the peak value of actual heat release rate dQ/dθ_max is a value calculated from the actual gas pressure in cylinder (for example, a value measured by the gas pressure sensor in cylinder).

Since the crank angle θd_dQ/dθdmax corresponding to the peak value of the heat release rate (below the broken line of FIG. 17) on the left side of the dashed line which is a region of the crank angle θ_dQ/dθmax corresponding to the peak value of actual heat release rate to be determined that misfire occurs, and the crank angle θd_dQ/dθdmax corresponding to the peak value of the heat release rate (above the broken line of FIG. 17) on the right side of the dashed line which is a region of the crank angle θ_dQ/dθmax corresponding to the peak value of actual heat release rate to be determined that misfire does not occur can be clearly separated, it is possible to set the determination threshold (broken line of FIG. 17) for determining the occurrence of misfire with good accuracy. This is because, unlike the crank angular acceleration α, the heat release rate dQ/dθd has little angular dependence, and the influence of the occurrence of misfire appears well.

As explained above, the presence or absence of the occurrence of abnormal combustion, such as preignition and misfire, can be determined by the heat release rate dQ/dθd with little angular dependence.

### <Determination of Abnormal Combustion>

Then, the abnormal combustion determination unit 53 determines presence or absence of the occurrence of the abnormal combustion of the internal combustion engine, based on the heat release rate dQ/dθd of each crank angle θd in the determination angle section Δθdet, which is calculated based on the increment of gas pressure by burning ΔPcyl_brn of each crank angle θd.

As mentioned above, unlike the crank angular acceleration α, the heat release rate dQ/dθd has little angular dependence, and the influence of the occurrence of abnormal combustion appears well. Accordingly, based on the heat release rate dQ/dθd calculated based on the increment of gas pressure by burning ΔPcyl_brn, the presence or absence of the occurrence of abnormal combustion can be determined with good accuracy.

### <Determination of Preignition>

In the present embodiment, the abnormal combustion determination unit 53 determines a peak value of the heat release rate dQ/dθd in the determination angle section Δθdet; and determines presence or absence of the occurrence of preignition by comparing the crank angle θd_dQ/dθdmax corresponding to the peak value with the angle threshold value for preignition Thθ_pre.

As explained using FIG. 16, there is a trend difference in θd_dQ/dθdmax between occurrence and non-occurrence of preignition. Accordingly, by setting the angle threshold value for preignition Thθ_pre between θd_dQ/dθdmax when preignition occurs, and θd_dQ/dθdmax when preignition does not occur, the presence or absence of the occurrence of preignition can be determined with good accuracy.

The abnormal combustion determination unit 53 determines that preignition occurs, when the crank angle θd_dQ/dθdmax corresponding to the peak value of dQ/dθd exceeds the angle threshold value for preignition Thθ_pre; and determines that preignition does not occur, when θd_dQ/dθdmax is less than the angle threshold value for preignition Thθ_pre.

The abnormal combustion determination unit 53 sets the angle threshold value for preignition Thθ_pre, based on the operating state of the internal combustion engine. For example, by referring angle threshold value data for preignition in which a relation between the operating state and the angle threshold value Thθ_pre is set, the abnormal combustion determination unit 53 sets the angle threshold value for preignition Thθ_pre corresponding to the present operating state. As the operating state of the internal combustion engine, the condition of the intake gas amount in cylinder (for example, the gas pressure in the intake pipe Pin, the intake air amount, or the like), the air-fuel ratio, the rotational speed (the rotational angle speed), and the like are used.

### <Determination of Misfire>

The abnormal combustion determination unit 53 determines a peak value of the heat release rate dQ/dθd in the determination angle section Δθdet; and determines presence or absence of the occurrence of misfire by comparing the crank angle θd_dQ/dθdmax corresponding to the peak value with the angle threshold value for misfire Thθ_mf.

As explained using FIG. 17, there is a trend difference in θd_dQ/dθdmax between occurrence and non-occurrence of misfire. Accordingly, by setting the angle threshold value for misfire Thθ_mf between θd_dQ/dθdmax when misfire occurs, and θd_dQ/dθdmax when misfire does not occur, the presence or absence of the occurrence of misfire can be determined with good accuracy.

The abnormal combustion determination unit 53 determines that misfire occurs, when the crank angle θd_dQ/dθdmax corresponding to the peak value of the heat release rate dQ/dθd is less than the angle threshold value for misfire Thθ_mf; and determines that misfire does not occur, when θd_dQ/dθdmax exceeds the angle threshold value for misfire Thθ_mf.

The abnormal combustion determination unit 53 sets the angle threshold value for misfire Thθ_mf, based on the operating state of the internal combustion engine. For example, by referring angle threshold value data for misfire in which a relation between the operating state and the angle threshold value Thθ_mf is set, the abnormal combustion determination unit 53 sets the angle threshold value for misfire Thθ_mf corresponding to the present operating state. As the operating state of the internal combustion engine, the condition of the intake gas amount in cylinder (for example, the gas pressure in the intake pipe Pin, the intake air amount, or the like), the air-fuel ratio, the rotational speed (the rotational angle speed), and the like are used.

<Calculation of the Peak Value of dQ/dθd Considering Misfire>

The abnormal combustion determination unit 53 determines a peak value of the heat release rate dQ/dθd in the determination angle section Δθdet; and sets a misfire state corresponding angle θd_mf preliminarily set in the determination angle section Δθdet, as the crank angle θd_dQ/dθdmax corresponding to the peak value, when the peak value is smaller than a misfire state corresponding threshold value ThdQ_mf.

According to this configuration, even when misfire occurred, the heat release rate dQ/dθd becomes near zero and it becomes difficult to determine the peak value, the misfire state corresponding angle θd_mf can be set as the crank angle θd_dQ/dθdmax corresponding to the peak value, θd_dQ/dθdmax can be prevented from varying for every combustion cycle, and the determination error of misfire can be suppressed.

### 3. Embodiment 3

The controller 50 according to Embodiment 3 will be explained with reference to drawings. The explanation for constituent parts the same as those in Embodiment 1 will be omitted. The basic configuration of the controller 50 according to the present embodiment is the same as that of Embodiment 1. Embodiment 3 is different from Embodiment 1 in that the gas pressure calculation unit 52 calculates the heat release rate dQ/dθd and a mass combustion rate MFB, and the abnormal combustion determination unit 53 determines presence or absence of the occurrence of abnormal combustion using the mass combustion rate MFB.

<Calculation of Heat Release Rate dQ/dθd>

Similar to Embodiment 2, the gas pressure calculation unit 52 calculates the heat release rate dQ/dθd per unit crank angle, based on the gas pressure in cylinder Pcyl and the crank angle θd, at each crank angle θd.

The gas pressure calculation unit 52 calculates the heat release rate dQ/dθd per unit crank angle using the equation (12), at each crank angle θd.

### <Calculation of Mass Combustion Rate MFB>

The gas pressure calculation unit 52 calculates a mass combustion rate MFB of each crank angle θd by integrating the heat release rate dQ/dθd in the combustion period.

In the present embodiment, using the next equation, the gas pressure calculation unit 52 calculates the mass combustion rate MFB of each crank angle θd, by dividing an interval integration value obtained by integrating the heat release rate dQ/dθd from the start angle θ0 to each crank angle θd, by a total integration value Q0 obtained by integrating the heat release rate dQ/dθd over the entire combustion period. The gas pressure calculation unit 52 performs a calculation processing which calculates the mass combustion rate MFB at each crank angle θd. The calculated mass combustion rate MFB of each crank angle θd is stored to the storage apparatus 91, such as RAM, similar to other calculation values.

$$\begin{matrix}[ Math . 13 ] & \\ MFB = \frac{{\int }_{θ 0}^{θ d} \frac{d ( Q )}{d ( θ d )} d ( θ d )}{Q 0} & ( 13 )\end{matrix}$$

### <Determination Principle of Abnormal Combustion>

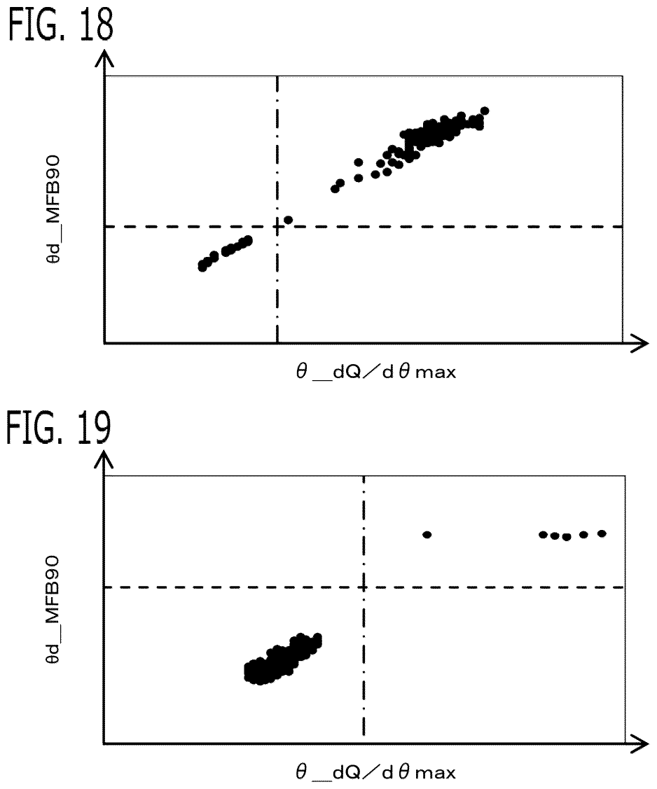

In the following, the determination principle of the abnormal combustion by the mass combustion rate MFB will be explained. FIG. 18 plots a relation between the crank angle θ_dQ/dθmax corresponding to the peak value of actual heat release rate dQ/dθ_max and the crank angle θd_MFB90 where the mass combustion rate MFB calculated by the controller 50 reaches a determination ratio (in this example, 90%) at each combustion cycle, in the case where the combustion cycles in which preignition occurs, and the combustion cycles in which preignition does not occur are intermingled. Herein, the peak value of actual heat release rate dQ/dθ_max is a value calculated from the actual gas pressure in cylinder (for example, a value measured by the gas pressure sensor in cylinder).

Since the crank angle θd_MFB90 where the mass combustion rate MFB reaches the determination ratio (90%) (above the broken line of FIG. 18) on the right side of the dashed line which is a region of the crank angle θ_dQ/dθmax corresponding to the peak value of actual heat release rate to be determined that preignition occurs, and the crank angle θd_MFB90 where the mass combustion rate MFB reaches the determination ratio (90%) (below the broken line of FIG. 18) on the left side of the dashed line which is a region of the crank angle θ_dQ/dθmax corresponding to the peak value of actual heat release rate to be determined that preignition does not occur can be clearly separated, it is possible to set the determination threshold (broken line of FIG. 18) for determining the occurrence of preignition with good accuracy. This is because, unlike the crank angular acceleration α, the mass combustion rate MFB has little angular dependence, and the influence of the occurrence of preignition appears well.

FIG. 19 plots a relation between the crank angle θ_dQ/dθmax corresponding to the peak value of actual heat release rate dQ/dθ_max and the crank angle θd_MFB90 where the mass combustion rate MFB calculated by the controller 50 reaches the determination ratio (90%) at each combustion cycle, in the case where the combustion cycles in which misfire occurs, and the combustion cycles in which misfire does not occur are intermingled. The scales of the horizontal axis and the vertical axis of FIG. 19 are expanded more than the scales of the horizontal axis and the vertical axis of FIG. 18. Herein, the peak value of actual heat release rate dQ/dθ_max is a value calculated from the actual gas pressure in cylinder (for example, a value measured by the gas pressure sensor in cylinder).

Since the crank angle θd_MFB90 where the mass combustion rate MFB reaches the determination ratio (90%) (below the broken line of FIG. 19) on the left side of the dashed line which is a region of the crank angle θ_dQ/dθmax corresponding to the peak value of actual heat release rate to be determined that misfire occurs, and the crank angle θd_MFB90 where the mass combustion rate MFB reaches the determination ratio (90%) (above the broken line of FIG. 19) on the right side of the dashed line which is a region of the crank angle θ_dQ/dθmax corresponding to the peak value of actual heat release rate to be determined that misfire does not occur can be clearly separated, it is possible to set the determination threshold (broken line of FIG. 19) for determining the occurrence of misfire with good accuracy. This is because, unlike the crank angular acceleration α, the mass combustion rate MFB has little angular dependence, and the influence of the occurrence of misfire appears well.

As explained above, the presence or absence of the occurrence of abnormal combustion, such as preignition and misfire, can be determined by the mass combustion rate MFB with little angular dependence.

### <Determination of Abnormal Combustion>

Then, the abnormal combustion determination unit 53 determines presence or absence of the occurrence of the abnormal combustion of the internal combustion engine, based on the mass combustion rate MFB of each crank angle θd in the determination angle section Δθdet, which is calculated based on the increment of gas pressure by burning ΔPcyl_brn of each crank angle θd.

As mentioned above, unlike the crank angular acceleration α, the mass combustion rate MFB has little angular dependence, and the influence of the occurrence of abnormal combustion appears well. Accordingly, based on the mass combustion rate MFB calculated based on the increment of gas pressure by burning ΔPcyl_brn, the presence or absence of the occurrence of abnormal combustion can be determined with good accuracy.

### <Determination of Preignition>

In the present embodiment, the abnormal combustion determination unit 53 determines the crank angle θd_MFB90 where the mass combustion rate MFB becomes the determination ratio (for example, 90%) in the determination angle section Δθdet; and determines presence or absence of the occurrence of preignition by comparing the crank angle θd_MFB90 corresponding to the determination ratio with the angle threshold value for preignition Thθ_pre. The determination ratio may be set to a ratio other than 90%.

As explained using FIG. 18, there is a trend difference in Gd_MFB90 between occurrence and non-occurrence of preignition. Accordingly, by setting the angle threshold value for preignition Thθ_pre between Gd_MFB90 when preignition occurs, and Gd_MFB90 when preignition does not occur, the presence or absence of the occurrence of preignition can be determined with good accuracy.

the abnormal combustion determination unit 53 determines that preignition occurs, when the crank angle θd_MFB90 where the mass combustion rate MFB becomes the determination ratio (90%) exceeds the angle threshold value for preignition Thθ_pre; and determines that preignition does not occur, when θ_MFB90 is less than the angle threshold value for preignition Thθ_pre.

The abnormal combustion determination unit 53 sets the angle threshold value for preignition Thθ_pre, based on the operating state of the internal combustion engine. For example, by referring angle threshold value data for preignition in which a relation between the operating state and the angle threshold value Thθ_pre is set, the abnormal combustion determination unit 53 sets the angle threshold value for preignition Thθ_pre corresponding to the present operating state. As the operating state of the internal combustion engine, the condition of the intake gas amount in cylinder (for example, the gas pressure in the intake pipe Pin, the intake air amount, or the like), the air-fuel ratio, the rotational speed (the rotational angle speed), and the like are used.

### <Determination of Misfire>

The abnormal combustion determination unit 53 determines the crank angle θd_MFB90 where the mass combustion rate MFB becomes the determination ratio (for example, 90%) in the determination angle section Δθdet; and determines presence or absence of the occurrence of misfire by comparing the crank angle θd_MFB90 corresponding to the determination ratio with the angle threshold value for misfire Thθ_mf.

As explained using FIG. 19, there is a trend difference in Gd_MFB90 between occurrence and non-occurrence of misfire. Accordingly, by setting the angle threshold value for misfire Thθ_mf between θd_MFB90 when misfire occurs, and θd_MFB90 when misfire does not occur, the presence or absence of the occurrence of misfire can be determined with good accuracy.

The abnormal combustion determination unit 53 determines that misfire occurs, when the crank angle θd_MFB90 where the mass combustion rate MFB becomes the determination ratio (90%) is less than the angle threshold value for misfire Thθ_mf; and determines that misfire does not occur, when Gd_MFB90 exceeds the angle threshold value for misfire Thθ_mf.

The abnormal combustion determination unit 53 sets the angle threshold value for misfire Thθ_mf, based on the operating state of the internal combustion engine. For example, by referring angle threshold value data for misfire in which a relation between the operating state and the angle threshold value Thθ_mf is set, the abnormal combustion determination unit 53 sets the angle threshold value for misfire Thθ_mf corresponding to the present operating state. As the operating state of the internal combustion engine, the condition of the intake gas amount in cylinder (for example, the gas pressure in the intake pipe Pin, the intake air amount, or the like), the air-fuel ratio, the rotational speed (the rotational angle speed), and the like are used.

### Other Embodiments

(1) In each of the above-mentioned Embodiments, there has been explained the case where the angle information detection unit 51 uses the output signal of the crank angle sensor 11. However, other crank angle sensor which detects the teeth of the link gear or the like may be provided, and the angle information detection unit 51 may use the output signal of other crank angle sensor.
(2) In each of the above-mentioned Embodiments, there was explained the case where the 3-cylinder engine whose cylinder number is three is used. However, the engine of any cylinder numbers (for example, 1-cylinder, 2-cylinder, 4-cylinder, 6-cylinder) may be used.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

1: Internal Combustion Engine, 11: Crank Angle Sensor, 50: Controller for Internal Combustion Engine, 51: Angle Information Detection Unit, 52: Gas Pressure Calculation Unit, 53: Abnormal Combustion Determination Unit, 54: Avoidance Control Unit, dQ/dθd: Heat Release Rate, Pcyl: Gas Pressure in Cylinder, Pcyl_Δbrnmax: Gas Pressure in Cylinder at Crank Angle Corresponding to Peak Value of Increment of Gas Pressure in Cylinder by burning, Pcyl_unbrn: Gas Pressure in Cylinder in Unburning State, ThΔP_0: Zero Excess Determination Threshold Value, ThΔP_mf: Misfire State Corresponding Threshold Value, Thθ_mf: Angle Threshold Value for Misfire, Thθ_pre: Angle Threshold Value for Preignition, ThP_mf: Gas Pressure Threshold Value for Misfire, ThP_pre: Gas Pressure Threshold Value for Preignition, ThdQ_mf: Misfire State Corresponding Threshold Value, ΔPcyl_brn: Increment of Gas Pressure by Burning, Δθdet: Determination Angle Section, ad: Crank Angular Acceleration, ed: Crank Angle, θd1: First Crank Angle, θd2: Second Crank Angle, θd3: Third Crank Angle, θd_Δbrnmax: Crank Angle Corresponding to Peak Value of Increment of Gas Pressure in Cylinder by Burning, θd_MFB90: Crank Angle Where Mass Combustion Rate Reaches Determination Ratio, θd_dQ/dθdmax: Crank Angle Corresponding to Peak Value of Heat Release Rate, θd_mf: Misfire State Corresponding Angle, ωd: Crank Angle Speed

1. A controller for an internal combustion engine, comprising at least one processor configured to implement:
an angle information detector that detects a crank angle and a crank angle acceleration, based on an output signal of a crank angle sensor;
a gas pressure calculator that calculates an increment of gas pressure torque by burning which is included in a gas pressure torque applied to a crankshaft by a gas pressure in cylinder, based on the crank angle and the crank angular acceleration, at each crank angle; and calculates an increment of gas pressure by burning, based on the increment of gas pressure torque by burning and the crank angle, at each crank angle; and
an abnormal combustion determiner that determines presence or absence of an occurrence of abnormal combustion of the internal combustion engine, based on the increment of gas pressure by burning at each crank angle within a determination angle section which is set corresponding to a combustion period.

2. The controller for the internal combustion engine according to claim 1,
wherein the gas pressure calculator calculates a gas pressure in cylinder in unburning state when assuming that an intake gas in cylinder is unburned, based on a present condition of an intake gas amount in cylinder, and the crank angle, at each crank angle; and calculates a gas pressure in cylinder, based on the gas pressure in cylinder in unburning state and the increment of gas pressure by burning, at each crank angle, and
wherein the Abnormal combustion determiner determines a peak value of the increment of gas pressure by burning in the determination angle section; and determines presence or absence of an occurrence of preignition by comparing the gas pressure in cylinder at the crank angle corresponding to the peak value a gas pressure threshold value for preignition.

3. The controller for the internal combustion engine according to claim 1,
wherein the Abnormal combustion determiner determines a peak value of the increment of gas pressure by burning in the determination angle section; and determines presence or absence of an occurrence of preignition by comparing the crank angle corresponding to the peak value with an angle threshold value for preignition.

4. The controller for the internal combustion engine according to claim 1,
wherein the gas pressure calculator calculates a gas pressure in cylinder in unburning state when assuming that an intake gas in cylinder is unburned, based on a present condition of an intake gas amount in cylinder, and the crank angle, at each crank angle; and calculates a gas pressure in cylinder, based on the gas pressure in cylinder in unburning state and the increment of gas pressure by burning, at each crank angle, and
wherein the Abnormal combustion determiner determines a peak value of the increment of gas pressure by burning in the determination angle section; and determines presence or absence of an occurrence of misfire by comparing the gas pressure in cylinder at the crank angle corresponding to the peak value with a gas pressure threshold value for misfire.

5. The controller for the internal combustion engine according to claim 1,
wherein the Abnormal combustion determiner determines a peak value of the increment of gas pressure by burning in the determination angle section; and determines presence or absence of an occurrence of misfire by comparing the crank angle corresponding to the peak value with an angle threshold value for misfire.

6. The controller for the internal combustion engine according to claim 1,
wherein the gas pressure calculator calculates a gas pressure in cylinder in unburning state when assuming that an intake gas in cylinder is unburned, based on a present condition of an intake gas amount in cylinder, and the crank angle, at each crank angle; calculates a gas pressure in cylinder, based on the gas pressure in cylinder in unburning state and the increment of gas pressure by burning, at each crank angle; and calculates a heat release rate per unit crank angle, based on the gas pressure in cylinder and the crank angle, at each crank angle, and
wherein the abnormal combustion determiner determines a peak value of the heat release rate in the determination angle section; and determines presence or absence of an occurrence of preignition by comparing the crank angle corresponding to the peak value with an angle threshold value for preignition.

7. The controller for the internal combustion engine according to claim 1,
wherein the gas pressure calculator calculates a gas pressure in cylinder in unburning state when assuming that an intake gas in cylinder is unburned, based on a present condition of an intake gas amount in cylinder, and the crank angle, at each crank angle; calculates a gas pressure in cylinder, based on the gas pressure in cylinder in unburning state and the increment of gas pressure by burning, at each crank angle; and calculates a heat release rate per unit crank angle, based on the gas pressure in cylinder and the crank angle, at each crank angle, and
wherein the abnormal combustion determiner determines a peak value of the heat release rate in the determination angle section; and determines presence or absence of an occurrence of misfire by comparing the crank angle corresponding to the peak value with an angle threshold value for misfire.

8. The controller for the internal combustion engine according to claim 1,
wherein the gas pressure calculator calculates a gas pressure in cylinder in unburning state when assuming that an intake gas in cylinder is unburned, based on a present condition of an intake gas amount in cylinder, and the crank angle, at each crank angle; calculates a gas pressure in cylinder, based on the gas pressure in cylinder in unburning state and the increment of gas pressure by burning, at each crank angle;
calculates a heat release rate per unit crank angle, based on the gas pressure in cylinder and the crank angle, at each crank angle; and
calculates a mass combustion rate of each crank angle by integrating the heat release rate in the combustion period, and
wherein the abnormal combustion determiner determines the crank angle where the mass combustion rate becomes a determination ratio in the determination angle section; and determines presence or absence of an occurrence of preignition by comparing the crank angle corresponding to the determination ratio with an angle threshold value for preignition.

9. The controller for the internal combustion engine according to claim 1,
wherein the gas pressure calculator calculates a gas pressure in cylinder in unburning state when assuming that an intake gas in cylinder is unburned, based on a present condition of an intake gas amount in cylinder, and the crank angle, at each crank angle; calculates a gas pressure in cylinder, based on the gas pressure in cylinder in unburning state and the increment of gas pressure by burning, at each crank angle;
calculates a heat release rate per unit crank angle, based on the gas pressure in cylinder and the crank angle, at each crank angle; and
calculates a mass combustion rate of each crank angle by integrating the heat release rate in the combustion period, and
wherein the abnormal combustion determiner determines the crank angle where the mass combustion rate becomes a determination ratio in the determination angle section; and determines presence or absence of an occurrence of misfire by comparing the crank angle corresponding to the determination ratio with an angle threshold value for misfire.

10. The controller for the internal combustion engine according to claim 1,
wherein, when changing the crank angle to a retard angle side in a compression stroke and a combustion stroke, the gas pressure calculator determines the crank angle where the increment of gas pressure by burning becomes larger than a zero excess determination threshold value in a compression stroke, as a first crank angle; determines the crank angle where the increment of gas pressure by burning becomes less than or equal to the zero excess determination threshold value after the first crank angle, as a second crank angle; determines the crank angle where the increment of gas pressure by burning becomes larger than the zero excess determination threshold value after the second crank angle in the combustion stroke after the compression stroke, as a third crank angle; and
sets the increment of gas pressure by burning in an angle section corresponding to from the first crank angle to the second crank angle to 0, when the first crank angle and the third crank angle exist.

11. The controller for the internal combustion engine according to claim 2,
wherein the Abnormal combustion determiner determines a peak value of the increment of gas pressure by burning in the determination angle section; and sets a misfire state corresponding angle preliminarily set in the determination angle section, as the crank angle corresponding to the peak value, when the peak value is smaller than a misfire state corresponding threshold value.

12. The controller for the internal combustion engine according to claim 1,
wherein at least one processor configured to further implement an avoidance controller that controls the internal combustion engine by changing a control parameter of the internal combustion engine so as to suppress the occurrence of abnormal combustion when it is determined that the abnormal combustion occurred.
